(19) United States
(12) Patent Application Publication
(10) Pub. No.: US 2007/0211824 A1
(43) Pub. Date: Sep. 13, 2007

(54) Digital quadrature modulation circuit provided with D/A converter and digital communication apparatus

(76) Inventor: Masazumi Yamazaki, Kanagawa (JP)

Correspondence Address: WENDEROTH, LIND & PONACK L.L.P., 2033 K. STREET, NW, SUITE 800, WASHINGTON, DC, 20006, US

(21) Appl. No.: 11/711,048

(22) Filed: Feb. 27, 2007

(30) Foreign Application Priority Data
Feb. 28, 2006 (JP) 2006-051727

(51) Int. Cl. H04L 27/12

(52) U.S. Cl. 375/302

(57) ABSTRACT

A digital quadrature modulation circuit includes a quadrature modulator, a D/A converter, and a frequency converter. The quadrature modulator orthogonally modulates local oscillation signals +cos ω0t and +sin ω0t according to inputted in-phase component data I0 and orthogonal component data Q0, adds up two digital signals I0 cos ω0t and Q0 sin ω0t after the quadrature modulation, and outputs a digital signal (I0 cos ω0t+Q0 sin ω0t) after the addition. The D/A converter converts the digital signal (I0 cos ω0t+Q0 sin ω0t) outputted from the quadrature modulator into an analog signal, and outputs the analog signal. The frequency converter converts a frequency of the analog signal from the D/A converter by mixing the analog signal with carrier signals +cos ω1t and +sin ω1t, respectively.

### BACKGROUND OF THE INVENTION

1. Field of the Invention

The present invention relates to a digital quadrature modulation circuit provided with D/A converter, and a digital communication apparatus, which are used in a radio communication terminal.

2. Description of the Related Art

FIG. 35 is a block diagram showing a configuration of a quadrature modulator according to a first prior art. In FIG. 35, in-phase component data and orthogonal component data, both of which are input digital signals, are wave-shaped by roll off filters (hereinafter referred to as ROFs) 21 and 22, D/A-converted into analog signals by digital/analog converters (hereinafter referred to as D/A converters) 23 and 24, and subjected to folded noise elimination by low pass filters (hereinafter referred to as LPFs) 25 and 26, respectively. Output signals of the respective LPFs 25 and 26 are inputted to an image-suppression frequency converter 27. The image-suppression frequency converter 27 includes a carrier signal generator circuit 28, mixers 29 and 210 and an adder 211, and converts each of output signals of LPFs 25 and 26 into intermediate-frequency signals or radio-frequency signals. The carrier signal generator circuit 28 includes a carrier signal generator 212 and a 90-degree phase shifter 213. In the image-suppression frequency converter 27, the mixers 29 and 210 mix the output signals I0 and Q0 of the LPFs 25 and 26 with carrier signals +cos ωct and −sin ωct, which are orthogonal to each other, respectively, and the adder 211 adds up the mixture signals. As a result, the quadrature modulator according to the first prior art can obtain a desired modulation signal (I0×cos ωct−Q0×sin ωct) from the two inputted digital signals I0 and Q0.

A digital quadrature modulation circuit capable of dispensing with adjustment of analog components has been recently proposed. FIG. 36 is a block diagram showing a configuration of a digital quadrature modulation circuit according to a second prior art. In FIG. 36, components corresponding to those of FIG. 35 are denoted by the same reference numerals as those of FIG. 35, and the descriptions thereof will be omitted. Referring to FIG. 36, the output signals I0 and Q0 of ROFs 21 and 22 are mixed by mixers 32 and 33 with local oscillation signals +cos ω2t and −sin ω2t which are orthogonal to each other, and are outputted from a local oscillation signal generator circuit 31, respectively. The mixture signals are added by an adder 34, and are mixed by mixers 35 and 36 with the local oscillation signals +cos ω2t and −sin ω2t, respectively. An output signal of the mixer 36 is subtracted from an output signal of the mixer 35 by a subtracter 37. Output signals of the adder 34 and the subtracter 37 are D/A-converted by D/A converters 23 and 24, and subjected to folded noise elimination by band pass filters (hereinafter referred to as BPFs) 38 and 39, and this leads to that signals I1 and Q1 expressed by the following Equations (1) and (2), respectively, are obtained. Further, in an image-suppression frequency converter 27, the mixers 29 and 210 mix the signals I1 and Q1 with carrier signals +cos ωct and −sin ωct, respectively, which are orthogonal to each other, and this leads to that signals I2 and Q2 expressed by the following Equations (3) and (4), respectively, are obtained:

$$\begin{matrix}I 1 = I 0 \times cos ω 2 t - Q 0 \times sin ω 2 t ; & ( 1 ) \\ Q 1 = I 0 \times sin ω2 t + Q 0 \times cos ω2 t ; & ( 2 ) \\ \begin{matrix}I 2 = I 1 \times cos ω ct \\ = \{ I 0 \times cos ( ω c + ω 2 ) t - Q 0 \times sin ( ω c + ω2 ) t \} / 2 + \\ \{ I 0 \times cos ( ω c - ω 2 ) t + Q 0 \times sin ( ω c - ω2 ) t \} / 2 ;\end{matrix} \\ and & ( 3 ) \\ \begin{matrix}Q 2 = Q 1 \times ( - sin ω ct ) \\ = \{ I 0 \times cos ( ω c + ω 2 ) t - Q 0 \times sin ( ω c + ω2 ) t \} / 2 - \\ \{ I 0 \times cos ( ω c - ω 2 ) t + Q 0 \times sin ( ω c - ω2 ) t \} / 2.\end{matrix} & ( 4 )\end{matrix}$$

Since the signals I1 and Q1 do not contain direct-current components, direct-current offset components can be eliminated without adjustment by capacitor coupling or the like, and this leads to suppression of carrier leakage generated by the direct-current offset components. Further, each of the signals I2 and Q2 is configured to include a desired signal component at an angular frequency (hereinafter referred to as a frequency simply) of (ωc+ω2) and an image signal component at a frequency of (ωc−ω2). Therefore, by causing the adder 211 to add up the signals I2 and Q2, the image signal component is canceled and a desired modulation signal I0×cos(ωc+ω2)t−Q0×sin(ωc+ω2)t can be obtained. Since incompleteness of the image-suppression frequency converter 27 and the signals I1 and Q1 causes leakage of a part of the image signal component (ωc−ω2) to output of the image-suppression frequency converter 27, a BPF 310 suppresses the leakage if needed. The digital quadrature modulation circuit according to the second prior art can dispense with adjustment of suppression of the carrier leakage.

Patent Documents related to the present invention are as follows:

(a) Japanese Patent Laid-open publication No. 2843699; and

(b) Japanese Patent Laid-open publication No. 3230786.

As a recent tendency, a radio communication terminal employs multilevel modulation or higher modulation symbol rate to realize high-capacity radio communication. Generally speaking, a clock frequency of a D/A converter is set to twice to four times as high as a modulation symbol rate. However, as multilevel modulation progresses, deterioration in modulation accuracy due to an in-band deviation or a phase distortion of an LPF or a BPF arranged in rear of the D/A converter becomes unnegligible. In order to avoid the deterioration in modulation accuracy, there may be proposed a method of setting the clock frequency of the D/A converter to four times or more as high as the modulation symbol rate, decreasing the number of degrees of the LPF or BPF, setting a cutoff frequency to high frequency to realize flat pass characteristics in a modulation signal band. However, the method has the following disadvantages. Since the frequency of the modulation symbol rate is higher, and the number of oversampling times increases, the clock frequency of the D/A converter is higher, and electric power consumption of the D/A converter increases.

### SUMMARY OF THE INVENTION

The object of the present invention is to provide a digital quadrature modulation circuit and a digital communication apparatus capable of solving the above-mentioned disadvantages according to the prior arts, decreasing the number of D/A converters, making circuit scale small, and reducing electric power consumption.

A digital quadrature modulation circuit according to a first invention is a digital quadrature modulation circuit including a quadrature modulator, a D/A converter and a frequency converter. The quadrature modulator orthogonally modulates a predetermined first local oscillation signal according to inputted first and second baseband signals, adds up two digital signals after the quadrature modulation, and outputs a digital signal after the addition. The D/A converter D/A-converts the digital signal after the quadrature modulation from the quadrature modulator into an analog signal, and outputs the analog signal. The frequency converter converts a frequency of the analog signal from the D/A converter by mixing the analog signal with a predetermined second local oscillation signal, and outputs the analog signal after the frequency-conversion.

In the above-mentioned digital quadrature modulation circuit, the quadrature modulator includes a first local oscillation signal generator, a first multiplier, a second multiplier and an adder. The first local oscillation signal generator generates and outputs the first local oscillation signal and a first orthogonal local oscillation signal, which are orthogonal to each other. The first multiplier multiplies the first baseband signal by the first local oscillation signal, and outputs a multiplied signal. The second multiplier multiplies the second baseband signal by the first orthogonal local oscillation signal, and outputs a multiplied signal. The adder adds up the signal from the first multiplier and the signal from the second multiplier, and outputs a digital signal after the addition.

In addition, in the above-mentioned digital quadrature modulation circuit, the second multiplier multiplies an inverted signal of the second baseband signal by the first orthogonal local oscillation signal, and outputs the multiplied signal.

Further, in the above-mentioned digital quadrature modulation circuit, the frequency converter includes a second local oscillation signal generator, a first mixer and a second mixer. The second local oscillation signal generator generates and outputs the second local oscillation signal and a second orthogonal local oscillation signal, which are orthogonal to each other. The first mixer converts the frequency of the analog signal from the D/A converter by mixing the analog signal with the second local oscillation signal, and outputs a converted analog signal. The second mixer converts the frequency of the analog signal from the D/A converter by mixing the analog signal with the second orthogonal local oscillation signal, and outputs a converted analog signal.

Still further, in the above-mentioned digital quadrature modulation circuit, the quadrature modulator includes a first selector. The first selector sequentially selects and outputs one of the first baseband signal, the second baseband signal, an inverted signal of the first baseband signal, and an inverted signal of the second baseband signal based on the first local oscillation signal.

In addition, in the above-mentioned digital quadrature modulation circuit, the frequency converter includes at least one selector including a first selector. The first selector includes a first frequency divider, a first orthogonal frequency-divided signal generator a first switch and a second switch. The first frequency divider divides the second local oscillation signal by a predetermined frequency-division ratio, and outputs a first frequency-divided signal. The first orthogonal frequency-divided signal generator generates a first orthogonal frequency-divided signal orthogonal to the first frequency-divided signal. The first switch selects and outputs one of the analog signal from the D/A converter and an inverted signal of the analog signal based on the first frequency-divided signal. The second switch selects and outputs one of the analog signal from the D/A converter and the inverted signal of the analog signal based on the first orthogonal frequency-divided signal.

Further, in the above-mentioned digital quadrature modulation circuit, the frequency converter further includes a second and a third selectors. The second selector includes a second frequency divider, a second orthogonal frequency-divided signal generator, a third switch and a fourth switch. The second frequency divider divides the second local oscillation signal by a predetermined frequency-division ratio, and outputs a second frequency-divided signal. The second orthogonal frequency-divided signal generator generates a second orthogonal frequency-divided signal orthogonal to the second frequency-divided signal. The third switch selects and outputs one of the analog signal from the first switch and the inverted signal of the analog signal based on the second frequency-divided signal. The fourth switch selects and outputs one of the analog signal from the first switch and the inverted signal of the analog signal based on the second orthogonal frequency-divided signal. The third selector includes a third frequency divider, a third orthogonal frequency-divided signal generator, a fifth switch and a sixth switch. The third frequency divider divides the second local oscillation signal by a predetermined frequency-division ratio, and outputs a third frequency-divided signal. The third orthogonal frequency-divided signal generator generates a third orthogonal frequency-divided signal orthogonal to the third frequency-divided signal. The fifth switch selects and outputs one of the analog signal from the second switch and the inverted signal of the analog signal based on the third frequency-divided signal. The sixth switch selects and outputs one of the analog signal from the second switch and the inverted signal of the analog signal based on the third orthogonal frequency-divided signal.

Here, the above-mentioned digital quadrature modulation circuit further includes a switching circuit. The switching circuit performs one of selectively switching a frequency of the second local oscillation signal and switching the frequency division ratios of the second and third frequency dividers.

Still further, the above-mentioned digital quadrature modulation circuit further includes a first filter. The first filter extracts a first predetermined frequency component from the signal from the frequency converter.

Here, in the above-mentioned digital quadrature modulation circuit, the first filter includes a first frequency changer circuit. The first frequency changer circuit changes a frequency band of the first required frequency component.

In addition, the above-mentioned digital quadrature modulation circuit further includes a second filter provided between the D/A converter and the frequency converter. The second filter extracts a second required frequency component from the analog signal from the D/A converter.

Further, in the above-mentioned digital quadrature modulation circuit, the second filter includes a second frequency changer circuit. The second frequency changer circuit changes a frequency band of the second required frequency component.

Still further, the above-mentioned digital quadrature modulation circuit further includes first and second wave-shaping filters. The first and second wave-shaping filters wave-shape the first and second baseband signals, respectively.

Further, the above-mentioned digital quadrature modulation circuit further includes a frequency divider. The frequency divider lowers a sampling frequency of at least one of the first and second wave-shaping filters.

A digital communication apparatus according to a second invention includes the above-mentioned digital quadrature modulation circuit.

The digital quadrature modulation circuit and the digital communication apparatus according to the present invention adds up the two orthogonally-modulated digital signals, and converts the resultant digital signal into the analog signal. Therefore, it is possible to decrease the number of D/A converters, make the circuit scale small, and reduce the electric power consumption.

### BRIEF DESCRIPTION OF THE DRAWINGS

Variable targets, features, and advantages of the present invention will become clear from the preferred embodiments described below with reference to the accompanying drawings.

FIG. 1 is a block diagram showing a configuration of a digital quadrature modulation circuit according to a first preferred embodiment of the present invention;

FIG. 2 is a block diagram showing a configuration of a digital communication apparatus including the digital quadrature modulation circuit of FIG. 1;

FIG. 3 is a block diagram showing a configuration of a digital quadrature modulation circuit according to a second preferred embodiment of the present invention;

FIG. 4 is a block diagram showing a configuration of a digital communication apparatus including the digital quadrature modulation circuit of FIG. 3;

FIG. 5 is a block diagram showing a configuration of a digital quadrature modulation circuit according to a third preferred embodiment of the present invention;

FIG. 6 is a block diagram showing a configuration of a digital communication apparatus including the digital quadrature modulation circuit of FIG. 5;

FIG. 7 is a block diagram showing a configuration of a digital quadrature modulation circuit according to a fourth preferred embodiment of the present invention;

FIG. 8 is a table for explaining operation performed by a controller 76 of FIG. 7;

FIG. 9 is a block diagram showing a configuration of a digital communication apparatus including the digital quadrature modulation circuit of FIG. 7;

FIG. 10 is a frequency arrangement diagram showing arrangements of frequency bands X, Y, and Z of FIG. 7;

FIG. 11 is a block diagram showing a configuration of a digital quadrature modulation circuit according to a fifth preferred embodiment of the present invention;

FIG. 12 is a circuit diagram showing one example of a detailed configuration of a selector 121 of FIG. 11;

FIG. 13 is a waveform diagram showing operations of respective signals in the selector 121 of FIG. 12;

FIG. 14 is a waveform diagram showing signals of respective parts of the selector 121 of FIG. 12;

FIG. 15 is a block diagram showing a configuration of a digital communication apparatus including the digital quadrature modulation circuit of FIG. 11;

FIG. 16 is a block diagram showing a configuration of a digital quadrature modulation circuit according to a sixth preferred embodiment of the present invention;

FIG. 17 is a waveform diagram showing signals of respective parts of a selector 121 of FIG. 16;

FIG. 18 is a block diagram showing a configuration of a digital quadrature modulation circuit according to a seventh preferred embodiment of the present invention;

FIG. 19(a) is a waveform diagram of an output signal Q0 of an ROF 182 and a local oscillation signal sin ωclkt subjected to multiplication by the selector 121 when a signal interpolator 184 is not provided, and FIG. 19(b) is a waveform diagram of the output signal Q0 of the signal interpolator 184 and the local oscillation signal sin ωclkt subjected to multiplication by the selector 121 when the signal interpolator 184 is provided;

FIG. 20 is a block diagram showing a configuration of a digital quadrature modulation circuit according to an eighth preferred embodiment of the present invention;

FIG. 21 is a circuit diagram showing one example of a detailed configuration of a selector 130 of FIG. 20;

FIG. 22 is a waveform diagram showing operation performed by a one-quarter frequency divider 136 of FIG. 21;

FIG. 23 is a block diagram showing a configuration of a digital quadrature modulation circuit according to a ninth preferred embodiment of the present invention;

FIG. 24 is a block diagram showing a detailed configuration of a selector 140 of FIG. 23;

FIG. 25 is a waveform diagram showing operations performed by a one-quarter frequency divider 149 and a 90-degree phase shifter 155 of FIG. 24;

FIG. 26 is a block diagram showing a detailed configuration of a clock signal generator circuit 145 of FIG. 23;

FIG. 27 is a block diagram showing a configuration of a digital quadrature modulation circuit according to a tenth preferred embodiment of the present invention;

FIG. 28 is a block diagram showing one example of a detailed configuration of a selector 160 of FIG. 27;

FIG. 29 is a block diagram showing one example of a detailed configuration of a selector 161 of FIG. 27;

FIG. 30 is a waveform diagram showing operation performed by a clock control circuit 175 of FIG. 29;

FIG. 31 is a block diagram showing a detailed configuration of a clock signal generator circuit 162 of FIG. 27;

FIG. 32 is a block diagram showing a configuration of a digital quadrature modulation circuit according to a modified preferred embodiment of the tenth preferred embodiment of the present invention;

FIG. 33 is a block diagram showing a detailed configuration of a clock signal generator circuit 192 of FIG. 32;

FIG. 34 is a block diagram showing a configuration of a digital quadrature modulation circuit according to an eleventh preferred embodiment of the present invention;

FIG. 35 is a block diagram showing a configuration of a quadrature modulator according to a first prior art;

FIG. 36 is a block diagram showing a configuration of a quadrature modulator according to a second prior art;

FIG. 37 is a table showing the relationship between mode settings of the respective selectors 140, 141 and 142 of FIG. 23 and obtained frequency components;

FIG. 38 is a table showing the relationship between mode settings made by the respective selectors 140, 141 and 142 of FIG. 23 and obtained frequency components;

FIG. 39 is a table showing output signals IH2 and QH2, an output signal of an image-suppression frequency converter 113, and obtained frequency components according to a state of a switch 164 of the selector 160 and those of switches 171 to 174 of the selector 161 of FIG. 27;

FIG. 40 is a circuit diagram showing a selector 121 and circuits arranged in front of the selector 121 according to the seventh preferred embodiment;

FIG. 41 is a waveform diagram showing operations of respective signals related to the selector 121 of FIG. 40;

FIG. 42 is an explanatory view for generation of orthogonal signals by a frequency divider, and is a circuit diagram of one delay flip-flop FF;

FIG. 43 is a circuit diagram of a one-half frequency divider constituted by two delay flip-flops FF1 and FF2 of FIG. 42 and an inverter INV1;

FIG. 44 is a timing chart for explaining operation of FIG. 43; and

FIG. 45 is a circuit diagram in the case where a one-quarter frequency divider is constituted by three delay flip-flops FF11, FF12 and FF13 of FIG. 42.

### DETAILED DESCRIPTION OF THE PREFERRED EMBODIMENTS

Preferred embodiments of the present invention will be described hereinafter with reference to the drawings. In the preferred embodiments, similar components are denoted by the same reference numerals, respectively.

### First Preferred Embodiment

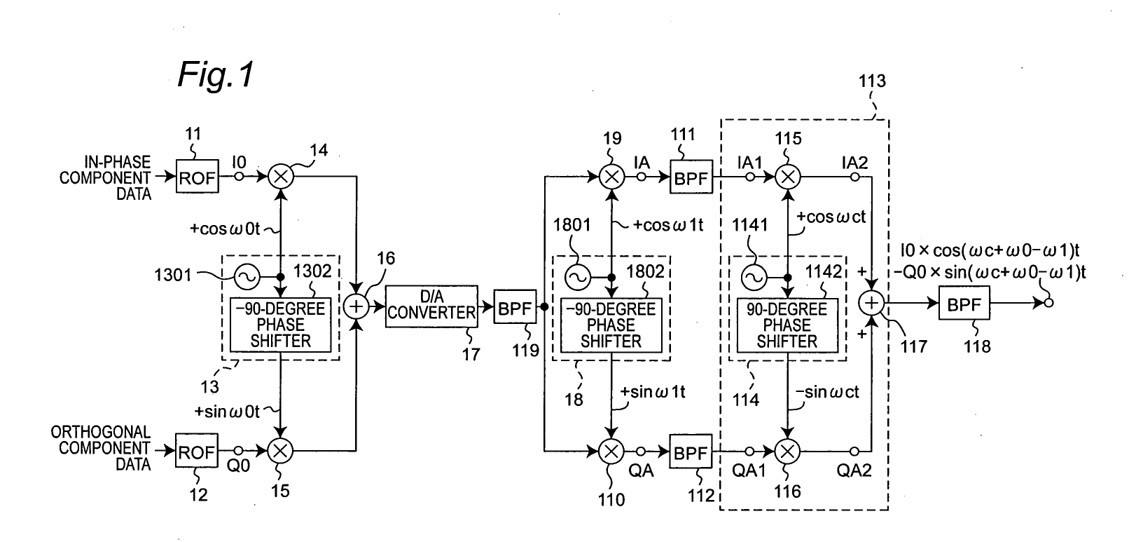

FIG. 1 is a block diagram showing a configuration of a digital quadrature modulation circuit according to a first preferred embodiment of the present invention. In FIG. 1, the digital quadrature modulation circuit according to the present preferred embodiment is configured to include ROFs 11 and 12, each of which is a type of a band-limiting filter, mixers 14, 15, 19 and 110, local oscillation signal generator circuits 13 and 18, an adder 16, a D/A converter 17, BPFs 119, 111, 112 and 118 and an image-suppression frequency converter 113.

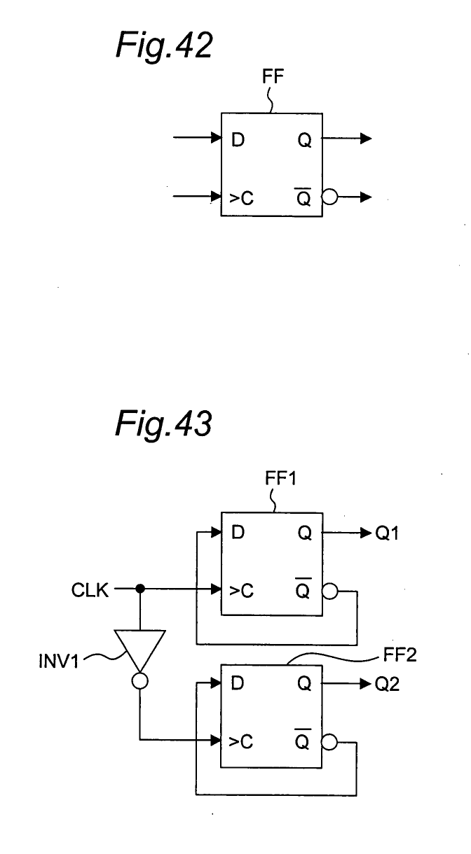

The local oscillation signal generator circuit 13 is configured to include a local oscillation signal generator 1301 that generates a local oscillation signal +cos ω0t (where “t” denotes time, and ω0 denotes an angular frequency (hereinafter referred to as a frequency simply) of the local oscillation signal), and a −90-degree phase shifter 1302 that shifts a phase of the local oscillation signal +cos ω0t by −90 degrees. The local oscillation signal generator circuit 18 is configured to include a local oscillation signal generator 1801 that generates a local oscillation signal +cos ω1t (where ω1 denotes a frequency of the local oscillation signal), and a −90-degree phase shifter 1802 that shifts a phase of the local oscillation signal +cos ω1t by −90 degrees. The image-suppression frequency converter 113 is configured to include mixers 115 and 116, a carrier signal generator circuit 114 and an adder 117. The carrier signal generator circuit 114 is configured to include a carrier signal generator 1141 that generates a carrier signal +cos ωct (where ωc denotes a frequency of the carrier signal) and a 90-degree phase shifter 1142 that shifts the carrier signal +cos ωct by 90 degrees. Each of the −90-degree phase shifter 1302 and 1802 and the 90-degree phase shifter 1142 is configured to include, for example, an RC phase shifter, a one-half frequency division flip-flop circuit, a one-quarter frequency division flip-flop circuit or the like. Generation of an orthogonal signal by constituting a one-half frequency divider or a one-quarter frequency divider using the flip-flop circuit will be described later in detail with reference to FIGS. 42 to 45.

The ROFs 11 and 12 limit the bandwidth of in-phase component data and that of orthogonal component data inputted to the ROFs 11 and 12 so as not to generate inter-symbol interference, and output the band-limited in-phase component data and the band-limited orthogonal component data to the mixers 14 and 15 as output signals I0 and Q0, respectively. The mixer 14 multiplies the local oscillation signal +cos ω0t from the local oscillation signal generator circuit 13 by the output signal I0 to mix the local oscillation signal +cos ω0t with the output signal I0, and outputs a mixture signal to the adder 16. The mixer 15 multiplies the local oscillation signal +sin ω0t from the local oscillation signal generator circuit 13 by the output signal Q0 to mix the local oscillation signal +sin ω0t with the output signal Q0, and outputs a mixture signal to the adder 16. The adder 16 adds up the mixture signals from the respective mixers 14 and 15, and outputs a resultant signal to the D/A converter 17. The output signal IQA of the adder 16 is expressed by the following Equation (5):
IQA=I0×cos ω0t+Q0×sin ω0t (5).

The D/A converter 17 D/A-converts the output signal IQA, which is a digital signal, and outputs the D/A-converted signal to the BPF 119. The BPF 119 band-pass filters the D/A-converted signal to extract a required frequency component, and outputs the filtered signal. The mixer 19 multiplies the local oscillation signal +cos ω1t from the local oscillation signal generator circuit 18 by the output signal of the BPF 119 to mix the local oscillation signal +cos ω1t with the output signal of the BPF 119, and outputs an output signal IA expressed by the following Equation (6) to the BPF 111. The mixer 110 multiplies the local oscillation signal +sin ω1t from the local oscillation signal generator circuit 18 by the output signal of the BPF 119 to mix the local oscillation signal +sin ω1t with the output signal of the BPF 119, and outputs an output signal QA expressed by the following Equation (7) to the BPF 112:

$$\begin{matrix}\begin{matrix}IA = \{ I 0 \times cos ( ω0 + ω1 ) t + Q 0 \times sin ( ω0 + ω1 ) t \} / 2 + \\ \{ I 0 \times cos ( ω0 - ω1 ) t + Q 0 \times sin ( ω0 - ω1 ) t \} / 2 ;\end{matrix} \\ and & ( 6 ) \\ \begin{matrix}QA = \{ I 0 \times sin ( ω0 + ω1 ) t - Q 0 \times cos ( ω0 + ω1 ) t \} / 2 - \\ \{ I 0 \times sin ( ω0 - ω1 ) t - Q 0 \times cos ( ω0 - ω1 ) t \} / 2.\end{matrix} & ( 7 )\end{matrix}$$

The BPFs 111 and 112 band-pass filter the output signals IA and QA so as to eliminate a frequency component (ω0+ω1) from the output signals IA and QA and to extract required frequency components, and output signals IA1 and QA 1 expressed by the following Equations (8) and (9) to the mixers 115 and 116 of the image-suppression frequency converter 113, respectively. It is to be noted that the BPFs 111 and 112 may be replaced by LPFs if the LPFs can function as stated above:
IA1={I0×cos(ω0−ω1)t+Q0×sin(ω0−ω1)t}/2 (8); and
QA1=−{I0×sin(ω0−ω1)t−Q0×cos ω0ω1)t}/2 (9).

The mixer 115 multiplies the carrier signal +cos ωct from the carrier signal generator circuit 114 by the output signal IA1 to mix the carrier signal +cos ωct with the output signal IA1, and outputs a mixture frequency-converted signal to the adder 117. The mixer 116 multiplies the carrier signal −sin ωct from the carrier signal generator circuit 114 by the output signal QA1 to mix the carrier signal −sin ωct with the output signal QA1, and outputs a mixture frequency-converted signal to the adder 117. The image-suppression frequency converter 113 converts the signals IA1 and QA1 into intermediate-frequency or radio-frequency signals by the mixers 115 and 116, respectively. The output signals IA2 and QA2 of the mixers 115 and 116 are expressed by the following Equations (10) and (11), respectively:

$$\begin{matrix}IA 2 = [ \begin{matrix}\{ I 0 \times \{ \begin{matrix}cos ( ω c + ω0 - ω1 ) t + \\ cos ( ω c - ω0 + ω1 ) t\end{matrix} \} + \\ Q 0 \times \{ \begin{matrix}sin ( ω c + ω0 - ω1 ) t - \\ sin ( ωc - ω0 + ω1 ) t\end{matrix} \}\end{matrix} ] / 4 ; \\ and & ( 10 ) \\ QA 2 = [ \begin{matrix}\{ I 0 \times \{ \begin{matrix}- cos ( ω c + ω0 - ω1 ) t + \\ cos ( ω c - ω0 + ω1 ) t\end{matrix} \} - \\ Q 0 \times \{ \begin{matrix}sin ( ω c + ω0 - ω1 ) t + \\ sin ( ωc - ω0 + ω1 ) t\end{matrix} \}\end{matrix} ] / 4. & ( 11 )\end{matrix}$$

The adder 117 adds up the output signals IA2 and QA2 to output a resultant signal to the BPF 118. The output signal (IA2+QA2) of the adder 117 is expressed by the following Equation (12), and an orthogonally modulated signal at a fundamental frequency of (ωc−ω0+ω1) is obtained. The BPF 118 band-pass filters the inputted signal so as to eliminate a leakage image component thereof and outputs a resultant signal:

$$\begin{matrix}IA 2 + QA 2 = I 0 \times \{ cos ( ω c - ω 0 + ω 1 ) t \} / 2 - \\ Q 0 \times \{ sin ( ω c - ω 0 + ω 1 ) t \} / 2.\end{matrix} \qquad ( 12 )$$

When the frequency ω0 is equal to the frequency ω1, then the respective output signals IA2 and QA2 of the mixers 115 and 116 can be expressed by the following Equations (13) and (14), and the orthogonally modulated signal having the frequency ωc of the carrier signal can be obtained. When the frequency ω0 is equal to the frequency ω1, since no image frequency is present, the BPF 118 can be omitted:
IA2=+(I0×cos ωct)/2 (13); and
QA2=−(Q0×sin ωct)/2 (14).

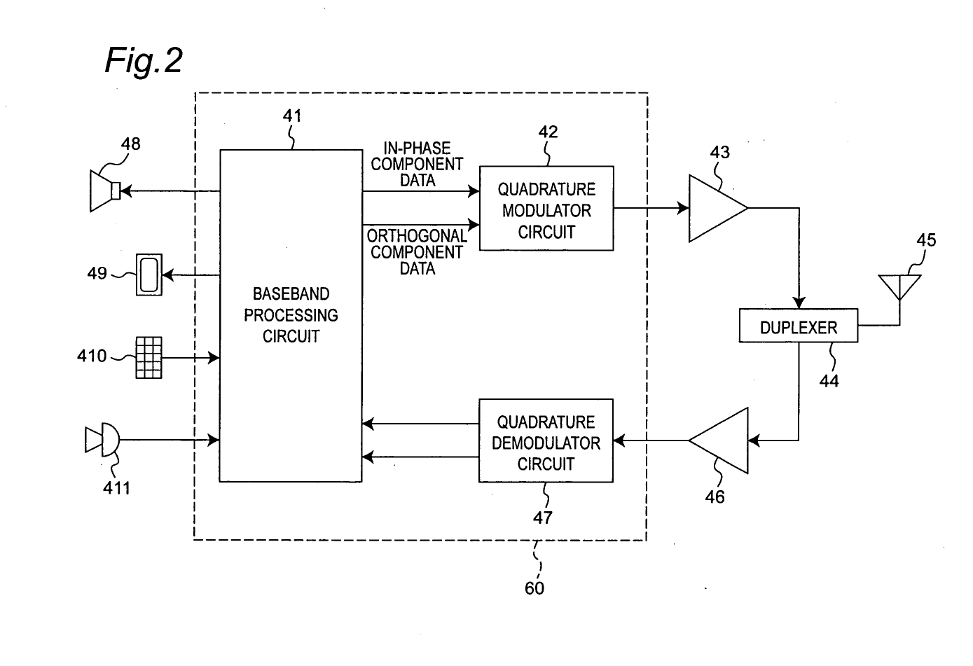

FIG. 2 is a block diagram showing a configuration of a digital communication apparatus including the digital quadrature modulation circuit 42 of FIG. 1. Referring to FIG. 2, the digital communication apparatus is configured to include a loudspeaker 48, a display 49, a keyboard 410, a microphone 411, a baseband processing circuit 41, a digital quadrature modulation circuit 42, an orthogonal demodulator circuit 47, an electric power amplifier 43, a low-noise amplifier 46, a duplexer 44 and an antenna 45. The baseband processing circuit 41, the digital quadrature modulation circuit 42 and the digital orthogonal demodulator circuit 47 are formed on one IC chip 60.

Information inputted via the keyboard 410 or an audio signal inputted via the microphone 411 is converted into in-phase component data and orthogonal component data by the baseband processing circuit 42. The in-phase component data and orthogonal component data are converted into a modulated signal by the digital quadrature modulation circuit 42. The modulated signal is transmitted to a counterpart communication apparatus, not shown, via the electric power amplifier 43, the duplexer 44 and the antenna 45. Further, a modulated signal transmitted from the counterpart communication apparatus, not shown, is demodulated by the digital orthogonal demodulator circuit 47 via the antenna 45, the duplexer 44 and the low-noise amplifier 46. The demodulated signals are subjected to conversion by the baseband processing circuit 41, and then, information is outputted via the display 49, or voice is outputted via the loudspeaker 48.

As described above, the digital quadrature modulation circuit according to the present preferred embodiment can decrease the number of D/A converters, make the circuit scale small, and reduce the electric power consumption, as compared with the digital quadrature modulation circuit s according to the prior arts. This leads to that a radio terminal such as a digital communication apparatus that can ensure long conversation time and long waiting time can be provided.

In addition, in FIG. 1, the BPF 118 is provided to alleviate requirements of the BPFs 111 and 112. However, the digital quadrature modulation circuit does not necessarily include the BPF 118.

### Second Preferred Embodiment

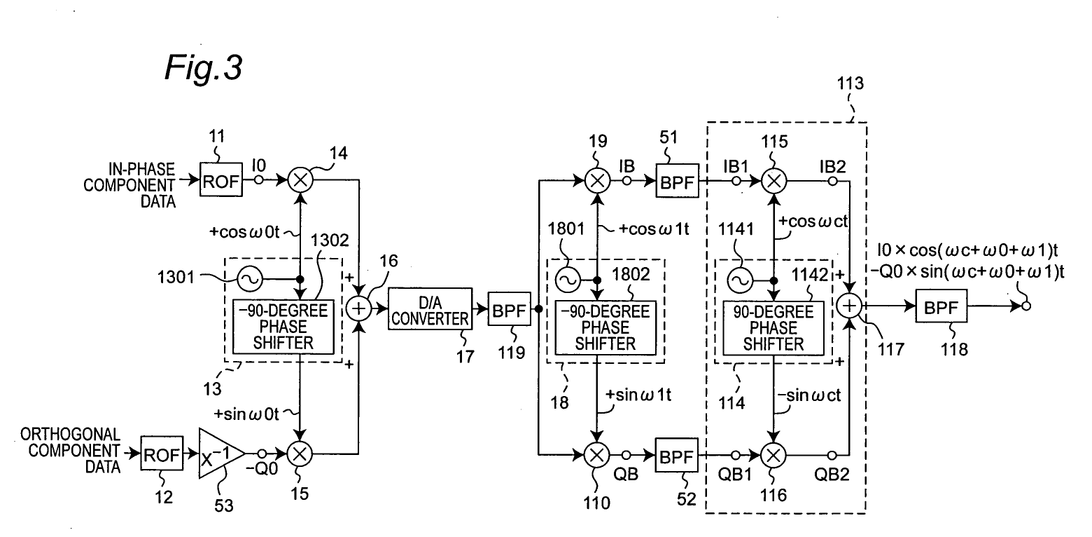

FIG. 3 is a block diagram showing a configuration of a digital quadrature modulation circuit according to a second preferred embodiment of the present invention. In FIG. 3, the digital quadrature modulation circuit according to the present preferred embodiment differs from that according to the first preferred embodiment of FIG. 1 in that a sign inverter 53 is added in rear of the ROF 12, and that BPFs 51 and 52 are provided in place of the BPFs 111 and 112. In other respects, since the digital quadrature modulation circuit according to the present preferred embodiment is similar to the digital quadrature modulation circuit according to the first preferred embodiment, the detailed description of the components denoted by the same reference numerals as those of FIG. 1 will be omitted.

Referring to FIG. 3, an output signal of the ROF 12 is inverted by the sign inverter 53. An output signal of the sign inverter 53 is −Q0, and an output signal IQB of the adder 16 is expressed by the following Equation (15):
IQB=I0×cos ω0t−Q0×sin ω0t (15).

The output signal IQB, which is a digital signal expressed by the Equation (15), is D/A-converted by the D/A converter 17 and band-pass filtered by the BPF 119 so as to extract a required frequency component. The mixer 19 multiplies the output signal of the BPF 119 by the local oscillation signal +cos ω1t from the local oscillation signal generator circuit 18 to mix the output signal of the BPF 119 with the local oscillation signal +cos ω1t, and outputs a mixture signal to the BPF 51. the mixer 110 multiplies the output signal of the BPF 119 by the local oscillation signal +sin ω1t from the local oscillation signal generator circuit to mix the output signal of the BPF 119 with the local oscillation signal +sin ω1t, and outputs a mixture signal to the BPF 52. Output signals IB and QB of the mixers 19 and 110 are expressed by the following Equations (16) and (17), respectively:

$$\begin{matrix}\begin{matrix}IB = \{ I 0 \times cos ( ω0 + ω1 ) t - Q 0 \times sin ( ω0 + ω1 ) t \} / 2 + \\ \{ I 0 \times cos ( ω0 - ω1 ) t - Q 0 \times sin ( ω0 - ω1 ) t \} / 2 ;\end{matrix} \\ and & ( 16 ) \\ \begin{matrix}QB = \{ I 0 \times sin ( ω0 + ω1 ) t + Q 0 \times cos ( ω0 + ω1 ) t \} / 2 + \\ \{ - I 0 \times sin ( ω0 - ω1 ) t - Q 0 \times cos ( ω0 - ω1 ) t \} / 2.\end{matrix} & ( 17 )\end{matrix}$$

The BPFs 51 and 52 band-pass filter the output signals IB and QB to eliminate the frequency component (ω0−ω1) to output signals IB1 and QB1 to mixers 115 and 116, respectively. The output signals IB1 and QB1 are expressed by the following Equations (18) and (19), respectively:

$$\begin{matrix}IB 1 = \{ I 0 \times cos ( ω 0 + ω 1 ) t - Q 0 \times sin ( ω 0 + ω 1 ) t \} / 2 ; \\ and & ( 18 ) \\ QB 1 = \{ I 0 \times sin ( ω 0 + ω 1 ) t + Q 0 \times cos ( ω 0 + ω 1 ) t \} / 2. & ( 19 )\end{matrix}$$

The mixers 115 and 116 multiply the output signals IB1 and QB1 of the BPFs 51 and 52 by the carrier signals +cos ωct and −sin ωct from a carrier signal generator circuit 114 to mix the output signals IB1 and QB1 with the carrier signals +cos ωct and −sin ωct, respectively, and output mixture frequency-converted signals IB2 and QB2, respectively. The output signals IB2 and QB2 of the mixers 115 and 116 are expressed by the following Equations (20) an (21), respectively:

$$\begin{matrix}IB 2 = [ \begin{matrix}\{ I 0 \times \{ \begin{matrix}cos ( ω c + ω0 + ω1 ) t + \\ cos ( ω c - ω0 - ω1 ) t\end{matrix} \} - \\ Q 0 \times \{ \begin{matrix}sin ( ω c + ω0 + ω1 ) t - \\ sin ( ωc - ω0 - ω1 ) t\end{matrix} \}\end{matrix} ] / 4 ; \\ and & ( 20 ) \\ QB 2 = [ \begin{matrix}\{ I 0 \times \{ \begin{matrix}cos ( ω c + ω0 + ω1 ) t - \\ cos ( ω c - ω0 - ω1 ) t\end{matrix} \} - \\ Q 0 \times \{ \begin{matrix}sin ( ω c + ω0 + ω1 ) t + \\ sin ( ωc - ω0 - ω1 ) t\end{matrix} \}\end{matrix} ] / 4. & ( 21 )\end{matrix}$$

The adder 117 adds up the output signals IB2 and QB2 to output a resultant signal to the BPF 118. The output signal (IB2+QB2) of the adder 117 is expressed by the following Equation (22), and this leads to that an orthogonally modulated signal at a fundamental frequency of (ωc+ω0+ω1) is obtained:

$$\begin{matrix}IB 2 + QB 2 = I 0 \times \{ cos ( ω c + ω 0 + ω 1 ) t \} / 2 - Q 0 \times \\ \{ sin ( ω c + ω0 + ω1 ) t \} / 2.\end{matrix} \qquad ( 22 )$$

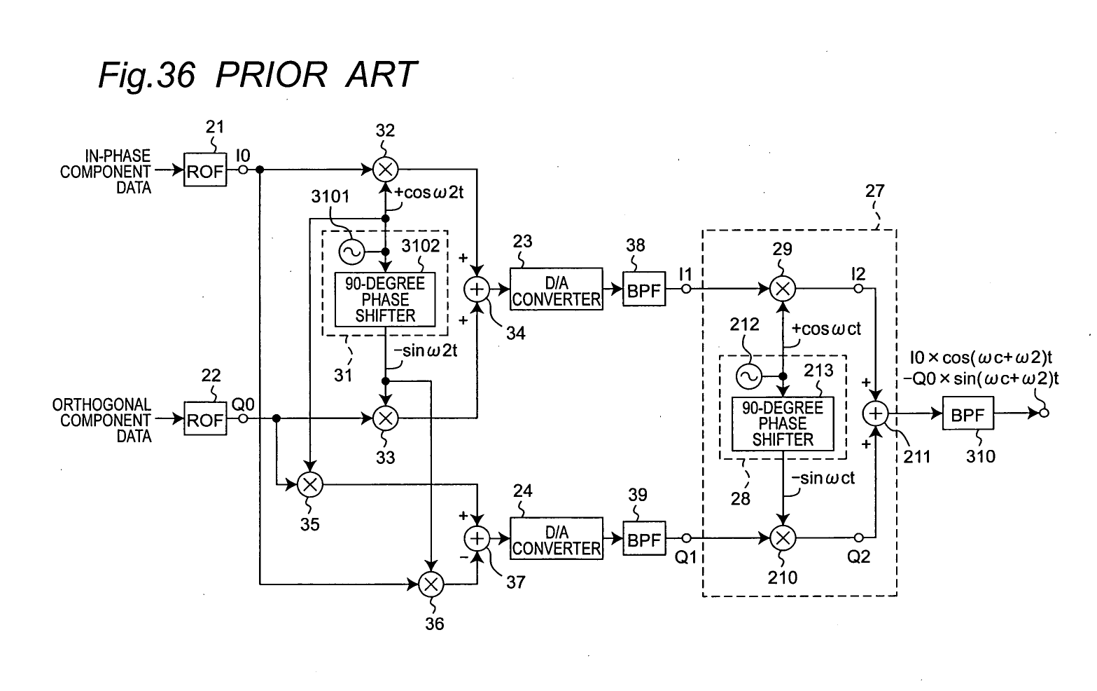

A difference between the desired frequency (ωc+ω0+ω1) and an image frequency (ωc−ω0−ω1) is (2ω0+2ω1). As compared with the difference (2ω0+2ω1), in the digital quadrature modulation circuit according to the second prior art of FIG. 36, a difference between the desired frequency (ωc+ω2) and the image frequency (ωc−ω2) is 2ω2. A maximum value of the frequency ω0 or ω2 does not exceed a half of a clock frequency of the D/A converter. Under the same condition, the digital quadrature modulation circuit according to the present preferred embodiment can ensure the difference between the desired frequency and the image frequency greater by 2ω1 than that according to the second prior art. Therefore, the digital quadrature modulation circuit according to the present preferred embodiment can advantageously alleviate requirements of a filter characteristic of the BPF 118 as compared with the second prior art.

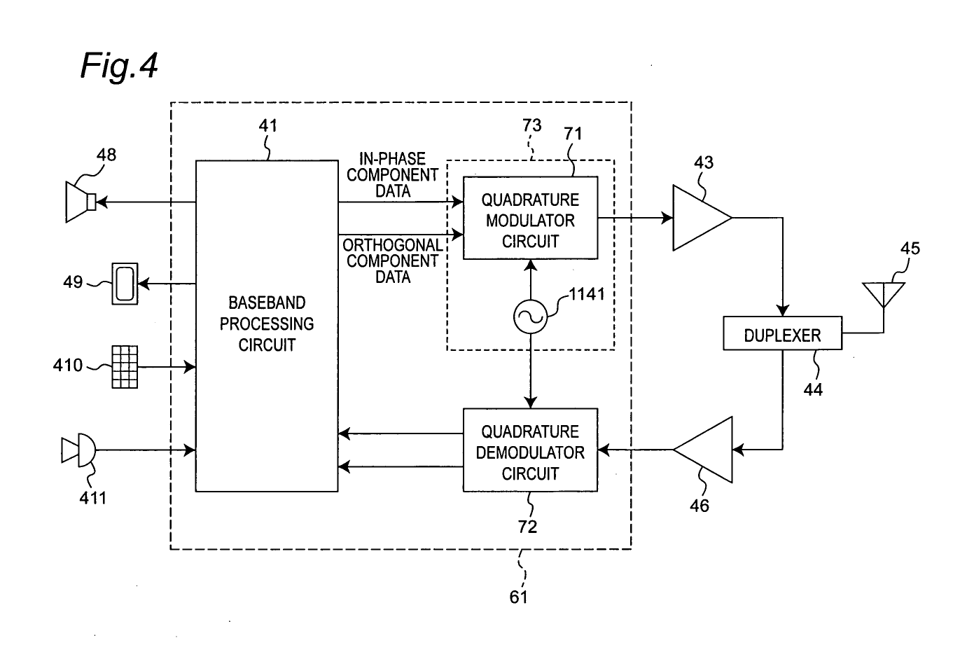

FIG. 4 is a block diagram showing a configuration of a digital communication apparatus including the digital quadrature modulation circuit 73 according to the present preferred embodiment. In FIG. 4, the digital communication apparatus differs from that according to the first preferred embodiment of FIG. 2 in that a digital quadrature modulation circuit 73 and a digital orthogonal demodulator circuit 72 are provided in place of the digital quadrature modulation circuit 42 and the digital orthogonal demodulator circuit 47, respectively. In other respects, since the digital quadrature modulation circuit according to the present preferred embodiment is similar to the digital quadrature modulation circuit according to the first preferred embodiment, the detailed description of the components denoted by the same reference numerals as those of FIG. 2 will be omitted. A baseband processing circuit 41, the digital quadrature modulation circuit 73, and the digital orthogonal demodulator circuit 72 are formed on one IC chip 61.

Referring to FIG. 4, the digital quadrature modulation circuit 73 according to the present preferred embodiment can output a signal at a different frequency from that of a signal generated by a carrier signal generator 1141 of the carrier signal generator circuit 114. Therefore, by setting a frequency (ω0+ω1) so as to be equal to a difference between a transmission frequency and a reception frequency, the digital quadrature modulation circuit 71 and the digital orthogonal demodulator circuit 73 in a radio communication system having a transmission frequency and a reception frequency different from each other can share the carrier signal generator circuit 1141. Therefore, the circuit scale can be made smaller and the electric power consumption can be reduced.

As described above, the digital quadrature modulation circuit according to the present preferred embodiment can decrease the number of D/A converters, as compared with the digital quadrature modulation circuit s according to the prior arts. Further, because the carrier signal generator 1141 can be shared, the digital quadrature modulation circuit according to the present preferred embodiment can further make the circuit scale smaller and further reduce the electric power consumption, as compared with the digital quadrature modulation circuit s according to the prior arts. This leads to that a radio terminal that can ensure longer conversation time and longer waiting time can be provided.

### Third Preferred Embodiment

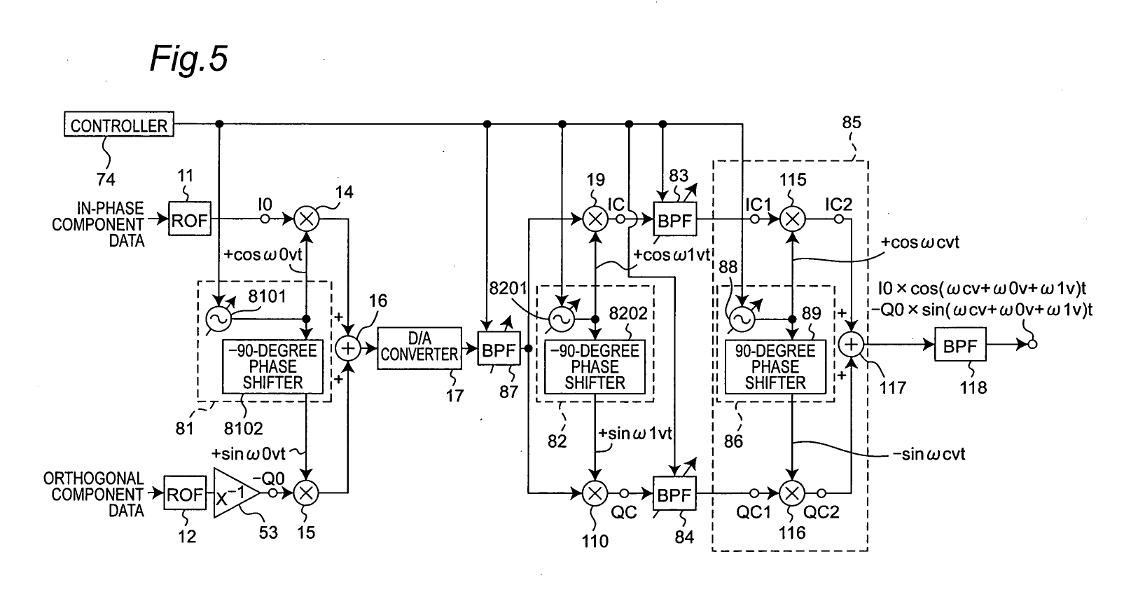

FIG. 5 is a block diagram showing a configuration of a digital quadrature modulation circuit according to a third preferred embodiment of the present invention. In FIG. 5, the digital quadrature modulation circuit according to the present preferred embodiment differs from the digital quadrature modulation circuit according to the first preferred embodiment of FIG. 1 in that a sign inverter 53 is added in rear of a ROF 12, that BPFs 83 and 84 are provided in place of the BPFs 111 and 112, respectively, that variable local oscillation signal generator circuits 81 and 82 and a variable carrier signal generator circuit 86 are provided in place of the local oscillation signal generator circuits 13 and 18 and the carrier signal generator circuit 114, respectively, and that a BPF 87 is provided in place of the BPF 119. The mixers 115 and 116, the variable carrier signal generator circuit 86 and an adder 117 constitute an image-suppression frequency converter 85. In other respects, since the digital quadrature modulation circuit according to the present preferred embodiment is similar to the digital quadrature modulation circuit according to the first preferred embodiment, the detailed description of the components denoted by the same reference numerals as those of FIG. 1 will be omitted.

Referring to FIG. 5, the variable local oscillation signal generator circuit 81 includes a variable local oscillation signal generator 8101 that generates a local oscillation signal +cos ω0vt (where v is a variable controlled by a controller 74), and a −90-degree phase shifter 8102 that shifts a phase of the local oscillation signal +cos ω0vt by −90 degrees. The variable local oscillation signal generator circuit 82 includes a variable local oscillation signal generator 8201 that generates a local oscillation signal +cos ω1vt, and a −90-degree phase shifter 8202 that shifts a phase of the local oscillation signal +cos ω1vt by −90 degrees. The variable carrier signal generator circuit 86 includes a variable carrier signal generator 88 that generates a carrier signal +cos ωcvt and a 90-degree phase shifter 89 that shifts a phase of the carrier signal +cos ωcvt by 90 degrees. The local oscillation signals +cos ω0vt and +cos ω1vt outputted from the variable local oscillation signal generators 8101 and 8201 and the carrier signal +cos ωcvt outputted from the variable carrier signal generator 88 are controlled by the controller 74. Further, respective pass characteristics of the BPFs 83, 84 and 87 are controlled by the controller 74.

The operation performed by the digital quadrature modulation circuit configured as stated above according to the present preferred embodiment will be described with reference to FIG. 5. The sign of an output signal of the ROF 12 is inverted by the sign inverter 90, so that an output signal of the sign inverter 53 is −Q0. The mixer 14 multiplies the local oscillation signal +cos ω0vt from the variable local oscillation signal generator 8101 by an output signal I0 to mix the local oscillation signal +cos ω0vt with the output signal I0, and outputs a mixture signal to an adder 16. The mixer 15 multiplies the local oscillation signal +sin ω0vt from the variable local oscillation signal generator 8101 by the output signal −Q0 to mix the local oscillation signal +sin ω0vt with the output signal −Q0, and outputs a mixture signal to the adder 16. An output signal IQC of the adder 16 is expressed by the following Equation (23):
IQC=I0×cos ω0vt−Q0×sin ω0vt (23).

The output signal IQC, which is a digital signal expressed by the Equation (23), is D/A-converted by the D/A converter 17, and then, is band-pass filtered by the BPF 87 to extract a required frequency component. The mixer 19 multiplies an output signal of the BPF 87 by the local oscillation signal +cos ω1vt from the local oscillation signal generator circuit 82 to mix the output signal of the BPF 87 with the local oscillation signal +cos ω1vt, and outputs a mixture signal to the BPF 83. The mixer 110 multiplies the output signal of the BPF 87 by the local oscillation signal +sin ω1vt from the local oscillation signal generator circuit to mix the output signal of the BPF 87 with the local oscillation signal +sin ω1vt, and outputs a mixture signal to the BPF 84. The respective output signals IC and QC of the mixers 19 and 110 are expressed by the following Equations (24) and (25), respectively:

$$\begin{matrix}\begin{matrix}IC = \{ I 0 \times cos ( ω 0 v + ω 1 v ) t - Q 0 \times sin ( ω0 v + ω 1 v ) t \} / 2 + \\ \{ I 0 \times cos ( ω 0 v - ω 1 v ) t - Q 0 \times sin ( ω0 v - ω 1 v ) t \} / 2 ;\end{matrix} \\ and & ( 24 ) \\ \begin{matrix}QC = \{ I 0 \times sin ( ω 0 v + ω 1 v ) t + Q 0 \times cos ( ω0 v + ω 1 v ) t \} / 2 + \\ \{ - I 0 \times sin ( ω 0 v - ω 1 v ) t - Q 0 \times cos ( ω0 v - ω 1 v ) t \} / 2.\end{matrix} & ( 25 )\end{matrix}$$

The BPFs 83 and 84 band-pass filter the output signals IC and QC to eliminate a frequency component (ω0v−ω1v), and output the band-pass filtered signals to mixers 115 and 116, respectively. The output signals IC1 and QC1 from BPFs 83 and 84 are expressed by the following Equations (26) and (27), respectively:

$$\begin{matrix}IC 1 = \{ I 0 \times cos ( ω 0 v + ω 1 v ) t - Q 0 \times sin ( ω 0 v + ω 1 v ) t \} / 2 ; \\ and & ( 26 ) \\ QC 1 = \{ I 0 \times sin ( ω 0 v + ω 1 v ) t + Q 0 \times cos ( ω 0 v + ω 1 v ) t \} / 2. & ( 27 )\end{matrix}$$

The mixers 115 and 116 multiply the output signals IC1 and QC1 from the BPFs 83 and 84 by the carrier signals +cos ωcvt and −sin ωcvt from the carrier signal generator circuit 86 to mix the output signals IC1 and QC1 with the carrier signals +cos ωcvt and −sin ωcvt, respectively, and output the mixture signals. The output signals IC2 and QC2 of the mixers 115 and 116 are expressed by the following Equations (28) and (29), respectively:

$$\begin{matrix}IC 2 = [ \{ I 0 \times \{ \begin{matrix}cos ( \begin{matrix}ω cv + \\ ω 0 v + \\ ω 1 v\end{matrix} ) t + \\ cos ( \begin{matrix}ω cv - \\ ω 0 v - \\ ω 1 v\end{matrix} ) t\end{matrix} \} - Q 0 \times \{ \begin{matrix}sin ( \begin{matrix}ω cv + \\ ω 0 v + \\ ω 1 v\end{matrix} ) t - \\ sin ( \begin{matrix}ω cv - \\ ω 0 v - \\ ω 1 v\end{matrix} ) t\end{matrix} \} ] / 4 ; \\ and & ( 28 ) \\ QC 2 = [ \{ I 0 \times \{ \begin{matrix}cos ( \begin{matrix}ω cv + \\ ω 0 v + \\ ω 1 v\end{matrix} ) t - \\ cos ( \begin{matrix}ω cv - \\ ω 0 v - \\ ω 1 v\end{matrix} ) t\end{matrix} \} - Q 0 \times \{ \begin{matrix}sin ( \begin{matrix}ω cv + \\ ω 0 v + \\ ω 1 v\end{matrix} ) t + \\ sin ( \begin{matrix}ω cv - \\ ω 0 v - \\ ω 1 v\end{matrix} ) t\end{matrix} \} ] / 4. & ( 29 )\end{matrix}$$

The adder 117 adds up the output signals IC2 and QC2 to output a resultant signal to the BPF 118. The output signal (IC2+QC2) of the adder 117 is expressed by the following Equation (30), and an orthogonally modulated signal at a fundamental frequency (ωcv+ωv+ω1v) is obtained:

$$IC 2 + QC 2 = I 0 \times \{ cos ( \begin{matrix}ω cv + \\ ω 0 v + \\ ω 1 v\end{matrix} ) t \} / 2 - Q 0 \times \{ sin ( \begin{matrix}ω cv + \\ ω 0 v + \\ ω 1 v\end{matrix} ) t \} / 2. \qquad ( 30 )$$

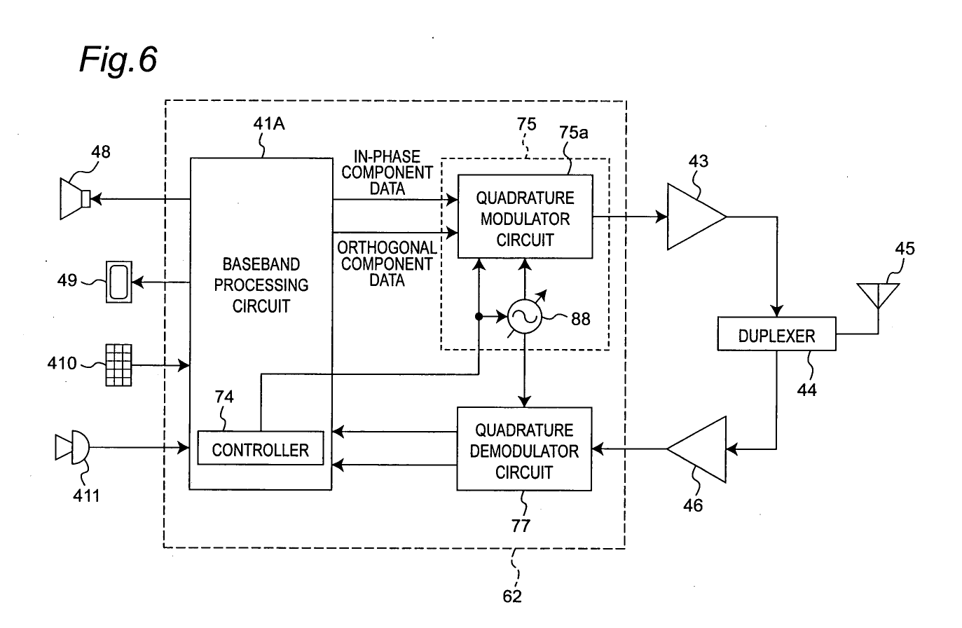

FIG. 6 is a block diagram showing a configuration of a digital communication apparatus including a digital quadrature modulation circuit unit 75 including a digital quadrature modulation circuit 75a according to the present preferred embodiment. In FIG. 6, the digital communication apparatus according to the present preferred embodiment differs from that according to the first preferred embodiment of FIG. 2 in that the digital quadrature modulation circuit unit 75, a digital orthogonal demodulator circuit 77 and a baseband processing circuit 41A are provided in place of the digital quadrature modulation circuit 42, the digital orthogonal demodulator circuit 47 and the baseband processing circuit 41, respectively. In other respects, since the digital communication apparatus according to the present preferred embodiment is similar to the digital communication apparatus according to the first preferred embodiment, the detailed description of the components denoted by the same reference numerals as those of FIG. 2 will be omitted. The baseband processing circuit 41A, the digital quadrature modulation circuit 74, and the digital orthogonal demodulator circuit 77 are formed on one IC chip 62.

In recent years, in order to reduce the number of components, direct modulation method for modulating at radio frequency has become common. Generally speaking, in radio communication, an allocated frequency band is divided into a plurality of channels and used. If the direct modulation method is applied to, for example, the configuration of the digital quadrature modulation circuit according to the first preferred embodiment of FIG. 1 or that of the digital quadrature modulation circuit according to the second preferred embodiment of FIG. 3, selecting channel is realized by changing the frequency ωc of the carrier signal generator circuit 114 of FIGS. 1 and 3, respectively. However, if a change width of the frequency ωc is broadened to cover a wide radio frequency band, performances such as phase noise of the carrier signal generator circuit 114 of FIGS. 1 and 3 or the like, and performances such as orthogonal accuracy and carrier leakage of the image-suppression frequency converter 113 or the like, are disadvantageously deteriorated, and transmitted signals are disadvantageously degraded.

By contrast, if the direct modulation method is applied to the digital quadrature modulation circuit according to the present preferred embodiment, a channel can be selected by causing the controller 74 of the baseband processing circuit 41 to change the frequencies ω0v, ω1v and ωcv. Preferably, characteristics of the carrier signal generator circuit 86 and the image-suppression frequency converter 85 may be optimized by switching channels to change the frequencies ω0v and ωcv and fixing the frequency ωcv.

As stated above, the digital quadrature modulation circuit according to the present preferred embodiment can decrease the number of D/A converters as compared with the prior arts, can select a channel by causing the controller 74 to change the frequencies ω0v, ω1v and ωcv, and as a result, even if the direct modulation method is applied to the digital quadrature modulation circuit according to the present preferred embodiment, transmitted signals does not degraded.

In the configuration of FIG. 5, the BPF 87 is provided in rear of the D/A converter 17 to alleviate the requirements of the BPFs 83 and 84. However, the digital quadrature modulation circuit does not necessarily include the BPF 87.

### Fourth Preferred Embodiment

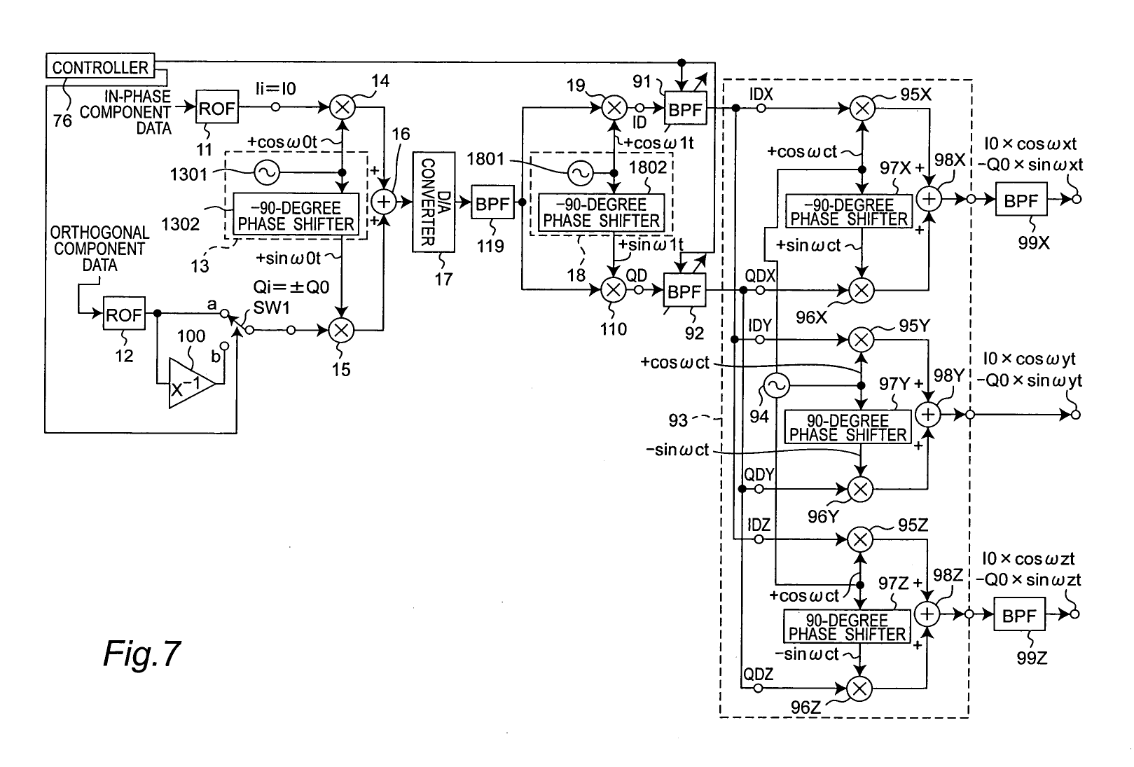

FIG. 7 is a block diagram showing a configuration of a digital quadrature modulation circuit according to a fourth preferred embodiment of the present invention. In FIG. 7, the digital quadrature modulation circuit according to the present preferred embodiment differs from that according to the first preferred embodiment of FIG. 1 in that a switch SW1 and a sign inverter 100 are added, that BPFs 91 and 92 are provided in place of the BPFs 111 and 112, and that an image-suppression frequency converter 93 and BPFs 99X and 99Z are provided in place of the image-suppression frequency converter 113 and the BPF 118 of FIG. 1. In other respects, since the digital quadrature modulation circuit according to the present preferred embodiment is similar to the digital quadrature modulation circuit according to the first preferred embodiment, the detailed description of the components denoted by the same reference numerals as those of FIG. 1 will be omitted.

The sign inverter 100, which is connected in parallel to a connection line between the ROF 12 and the mixer 15, inverts or does not invert an output signal of the ROF 12 using the switch SW1, and outputs a resultant signal to the mixer 15. The switch SW1 is controlled to be turned on or off by a controller 76, and pass characteristics of the BPFs 91 and 92 are also controlled by the controller 76.

The image-suppression frequency converter 93 includes three output terminals corresponding to three frequency bands X, Y and Z, respectively. The image-suppression frequency converter 93 is configured to include a carrier signal generator 94, mixers 95X, 95Y, 95Z, 96X, 96Y and 96Z, a −90-degree phase shifter 97X, 90-degree phase shifters 97Y and 97Z, and adders 98X, 98Y and 98Z. Each of the phase shifters 97X, 97Y and 97Z is, for example, an RC phase shifter, a one-half frequency division flip-flop, a one-quarter frequency division flip-flop or the like. The carrier signal generator 94 generates and outputs a carrier signal +cos ωct (where “t” is time and ωc is frequency). The mixers 95X and 96X, the −90-degree phase shifter 97X and the adder 98X operate at the frequency band X. The mixers 95Y and 96Y, the 90-degree phase shifter 97Y and the adder 98Y operate at the frequency band Y. The mixers 95Z and 96Z, the 90-degree phase shifter 97Z and the adder 98Z operate at the frequency band Z. The mixers 95X, 95Y and 95Z operate similarly to the mixer 115 of FIG. 1, the mixers 96X, 96Y and 96Z operate similarly to the mixer 116 of FIG. 1, and the adders 98X, 98Y and 98Z operate similarly to the adder 117 of FIG. 1.

It is assumed that output signals of the ROFs 11 and 12 are Ii and Qi, respectively. The output signal Ii is equal to an output signal I0. When the switch SW1 does not select a side of the sign inverter 100 (i.e., the switch SW1 selects a contact “a” side), the output signal Qi is equal to an output signal Q0. When the switch SW1 selects a side of the sign inverter 100 (i.e., the switch SW1 selects a contact “b” side), the output signal Qi is equal to an output signal −Q0.

The controller 76 controls a state of the switch SW1 and the pass characteristics of the respective BPFs 91 and 92 according to which of the frequency bands X, Y, and Z is used.

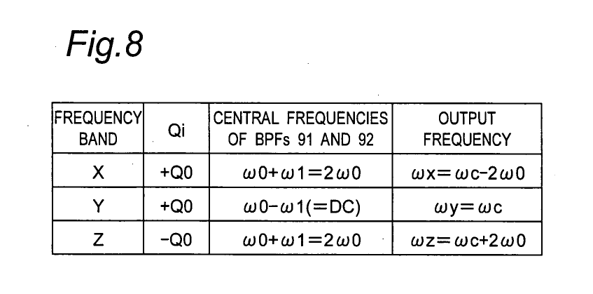

FIG. 8 is a table for explaining operation performed by the controller 76 of the digital quadrature modulation circuit according to the present preferred embodiment. Referring to FIG. 8, when the frequency band X is selected, then the switch SW1 is controlled not to select the sign inverter 100, and the pass characteristics of the BPFs 91 and 92 is controlled to a central frequency of (ω0+ω1). In this case, when the frequency ω0 is equal to the frequency ω1, the central frequency (ω0+ω1) is equal to a frequency of 2ω0. When the frequency band Y is selected, then the switch SW1 is controlled not to select the sign inverter 100, and the pass characteristics of the BPFs 91 and 92 is controlled to a central frequency of (ω0−ω1). In this case, when the frequency ω0 is equal to the frequency ω1, the central frequency (ω0−ω1) is equal to DC level. When the frequency band Z is selected, then the switch SW1 is controlled to select the sign inverter 100, and the pass characteristics of the BPFs 91 and 92 are controlled to the central frequency of (ω0+ω1). In this case, when the frequency ω0 is equal to the frequency ω1, the central frequency (ω0+ω1) is equal to the frequency of 2ω0.

The operation performed by the digital quadrature modulation circuit according to the present preferred embodiment will be described with reference to FIG. 7 according to respective used frequency bands. First of all, when the used frequency band X is selected, the switch SW1 does not select the sign inverter 100. Therefore, the digital quadrature modulation circuit performs a similar operation to that performed by the digital quadrature modulation circuit according to the first preferred embodiment of FIG. 1, and an output signal IQD of the D/A converter 17 is expressed by the following Equation (31). Further, output signals ID and QD of mixers 19 and 110 are expressed by the following Equations (32) and (33), respectively:
IQD=I0×cos ω0t+Q0×sin ω0t (31);
ID=I0/2+(I0×cos 2ω0t+Q0×sin 2ω0t)/2 (32); and
QD=Q0/2+(I0×sin 2ω0t−Q0×cos 2ω0t)/2 (33).

The BPFs 91 and 92 are switched by the controller 76 to have such band-passing characteristics as to pass a signal component centered around the frequency of 2ω0. Therefore, signals IDX and QDX applied to the respective mixers 95X and 96X are expressed by the following Equations (34) and (35):
IDX=(I0×cos 2ω0t+Q0×sin 2ω0t)/2 (34); and
QDX=(I0×sin 2ω0t−Q0×cos 2ω0t)/2 (35).

The mixer 95X multiplies the carrier signal +cos ωct from the carrier signal generator 94 by the output signal IDX to mix the carrier signal +cos ωct with the output signal IDX, and outputs a mixture signal to the adder 98X. The mixer 96X multiplies the carrier signal +sin ωct obtained by causing the −90-degree phase shifter 97X to shift a phase of the carrier signal +cos ωct from the carrier signal generator 94 by −90 degrees by the output signal QDX to mix the carrier signal +sin ωct with the output signal QDX, and outputs a mixture signal to the adder 98X. The adder 98X adds up output signals of the respective mixers 95X and 96X, outputs an output signal IQDX expressed by the following Equation (36), and a desired orthogonally modulated signal having a fundamental frequency component (ωx=ωc−2ω0) is obtained. The BPF 99X band-pass filters the output signal IQDX to eliminate a leakage image component:

$$\begin{matrix}IQDX = IDX \times cos ω ct + QDX \times sin ω ct \\ = \{ I 0 \times cos ( ω c - 2 ω0 ) t - Q 0 \times sin ( ω c - 2 ω0 ) t \} / 2.\end{matrix} \qquad ( 36 )$$

Next, when the used frequency band Y is selected, the output signal IQD of the D/A converter 17 is expressed by the following Equation (37). Further, the output signals ID and QD of the respective mixers 19 and 110 are expressed by the following Equations (38) and (39):
IQD=I0×cos ω0t+Q0×sin ω0t (37);
ID=I0/2+(I0×cos 2ω0t+Q0×sin 2ω0t)/2 (38); and
QD=Q0/2+(I0×sin 2ω0t−Q0×cos 2ω0t)/2 (39).

The BPFs 91 and 92 are switched by the controller 76 to have such band-passing characteristics as to pass a baseband signal component. Therefore, signals IDY and QDY applied to the respective mixers 95Y and 96Y are expressed by the following Equations (40) and (41):
IDY=I0/2 (40); and
QDX=Q0/2 (41).

The mixer 95Y multiplies the carrier signal +cos ωct from the carrier signal generator 94 by the output signal IDY to mix the carrier signal +cos ωct with the output signal IDY, and outputs a mixture signal to the adder 98Y. The mixer 96Y multiplies the carrier signal −sin ωct obtained by causing the 90-degree phase shifter 97Y to shift the phase of the carrier signal +cos ωct from the carrier signal generator 94 by 90 degrees by the output signal QDY to mix the carrier signal −sin ωct with the output signal QDY, and outputs a mixture signal to the adder 98Y. The adder 98Y adds up output signals of the respective mixers 95Y and 96Y, outputs an output signal IQDY expressed by the following Equation (42). A desired orthogonally modulated signal having a fundamental frequency component (ωy=ωc) is obtained. In this case, since no image frequency is present, there is no need to provide a filter for eliminating the leakage image component:

$$\begin{matrix}IQDY = IDY \times cos ω ct - QDY \times sin ω ct \\ = \{ I 0 \times cos ω ct - Q 0 \times sin ω ct \} / 2.\end{matrix} \qquad ( 42 )$$

Next, when the used frequency band Z is selected, the output signal IQD of the D/A converter 17 is expressed by the following Equation (43). Further, the output signals ID and QD of the respective mixers 19 and 110 are expressed by the following Equations (44) and (45):
IQD=I0×cos ω0t−Q0×sin ω0t (43);
ID=I0/2+(I0×cos 2ω0t−Q0×sin 2ω0t)/2 (44); and
QD=−Q0/2+(I0×sin 2ω0t+Q0×cos 2ω0t)/2 (45).

The BPFs 91 and 92 are switched by the controller 76 to have such band-passing characteristics as to pass a signal component centered around the frequency of 2ω0. Therefore, signals IDZ and QDZ applied to the respective mixers 95Z and 96Z are expressed by the following Equations (46) and (47):
IDZ=(I0×cos 2ω0t−Q0×sin 2ω0t)/2 (46); and
QDZ=(I0×sin 2ω0t+Q0×cos 2ω0t)/2 (47).

The mixer 95Z multiplies the carrier signal +cos ωct from the carrier signal generator 94 by the output signal IDZ to mix the carrier signal +cos ωct with the output signal IDZ, and outputs a mixture signal to the adder 98Z. The mixer 96Z multiplies the carrier signal −sin ωct obtained by causing the 90-degree phase shifter 97Z to shift the phase of the carrier signal +cos ωct from the carrier signal generator 94 by 90 degrees by the output signal QDZ to mix the carrier signal −sin ωct with the output signal QDZ, and outputs a mixture signal to the adder 98Z. The adder 98Z adds up output signals of the respective mixers 95Z and 96Z, outputs an output signal IQDZ expressed by the following Equation (48). A desired orthogonally modulated signal having a fundamental frequency component (ωz=ωc+2ω0) is obtained. Further, the BPF 99Z band-pass filters the output signal IQDZ to eliminate a leakage image component and to extract a desired frequency component:

$$\begin{matrix}IQDZ = IDZ \times cos ω ct - QDZ \times sin ω ct \\ = \{ I 0 \times cos ( ω c + 2 ω 0 ) t - Q 0 \times sin ( ω c + 2 ω0 ) \} / 2.\end{matrix} \qquad ( 48 )$$

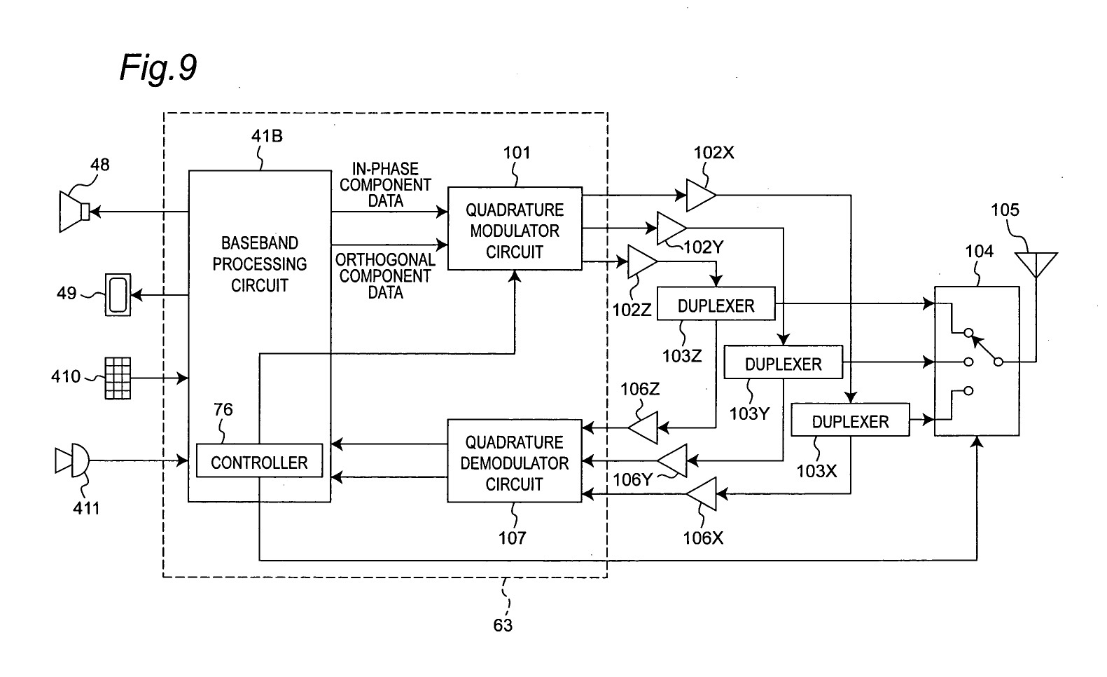

FIG. 9 is a block diagram of a configuration of a digital communication apparatus including a digital quadrature modulation circuit 101 according to the present preferred embodiment. In FIG. 9, the digital communication apparatus differs from that according to the first preferred embodiment of FIG. 2 in that the digital quadrature modulation circuit 101, a digital orthogonal demodulator circuit 107 and a baseband processing circuit 41B are provided in place of the digital quadrature modulation circuit 42, the digital orthogonal demodulator circuit 47 and the baseband processing circuit 41, and that electric power amplifiers 102X, 102Y and 102Z, low-noise amplifiers 106X, 106Y and 106Z, duplexers 103X, 103Y and 103Z, and a switch 104 are provided in place of the electric power amplifier 43, the low-noise amplifier 46 and the duplexer 44. In other respects, since the digital communication apparatus according to the present preferred embodiment of FIG. 9 is similar to the digital communication apparatus according to the first preferred embodiment, the detailed description of the components denoted by the same reference numerals as those of FIG. 2 will be omitted. The baseband processing circuit 41B, the digital quadrature modulation circuit 101, and the digital orthogonal demodulator circuit 107 are formed on one IC chip 63.

The switch 104 connects one of the duplexers 103X, 103Y and 103Z corresponding to the selected frequency band to the antenna 105 according to which of the used frequency bands X, Y and Z is selected under control of the controller 76.

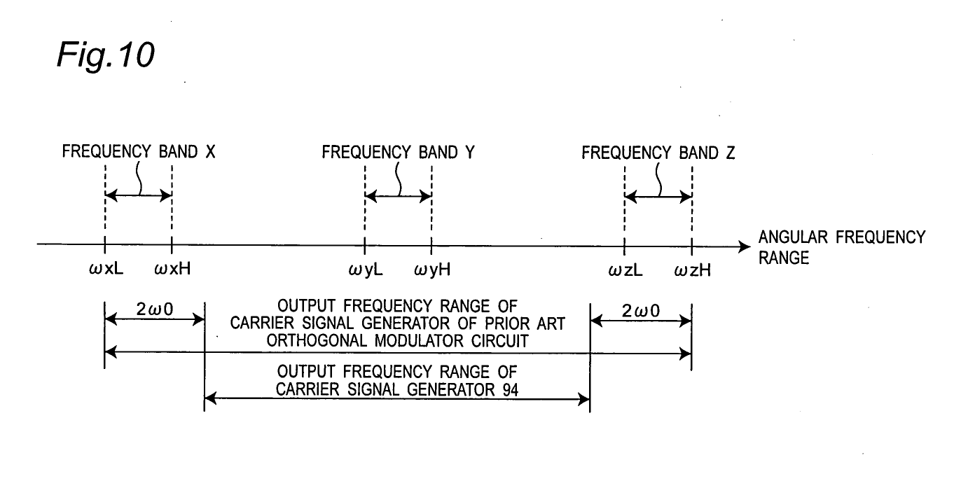

FIG. 10 is a frequency arrangement diagram showing arrangements of the frequency bands X, Y and Z in the digital quadrature modulation circuit according to the present preferred embodiment. As shown in FIG. 10, for example, the frequency band X is arranged in a lowest frequency range, and the frequency band Z is arranged in a highest frequency range. In FIG. 10, lower limit frequencies of the frequency bands X, Y and Z are ωxL, ωyL and ωzL, and upper limit frequencies thereof are ωxH, ωyH and ωzH, respectively.

As shown in FIG. 10, if the carrier signal generator 94 supplies a carrier signal to the image-suppression frequency converter operating in each of the frequency bands X, Y and Z, the carrier signal generator 94 is required to output an output frequency ωc in a range from the frequency ωxL, which is the lowest frequency, to the frequency ωxH, which is the highest frequency in the quadrature modulation circuit according to the prior arts. In the digital quadrature modulation circuit according to the present preferred embodiment, the carrier signal generator 94 outputs the output frequency ωc in a range from a frequency (ωxL+2ω0) to a frequency (ωzH−2ω0), and as a result, the range of the output frequency can be narrowed by 4ω0, as compared with the prior arts. This can leads to facilitate optimizing characteristics of the carrier signal generator 94 as compared with the prior arts.

In addition, in the present preferred embodiment, the instance of selecting one of the three frequency bands, which are the used frequency bands X, Y and Z, has been described. However, the present invention is not limited to this configuration but the quadrature modulation circuit according to the present preferred embodiment may be configured to select one frequency band from among two or four or more frequency bands.

Further, the configuration according to the third preferred embodiment may be applied to that according to the present preferred embodiment to optimize, the characteristics of the image-suppression frequency converter 93 by switching frequency channels by switching over the frequencies ω0v and ω1v by the controller 76 and fixing the frequency ωcv.

Still further, the digital quadrature modulation circuit according to the present preferred embodiment includes one carrier signal generator 94. Alternatively, the digital quadrature modulation circuit according to the present preferred embodiment may include a plurality of carrier signal generators to generate signals at different frequencies from each other according to the respective frequency bands X, Y and Z.

### Fifth Preferred Embodiment

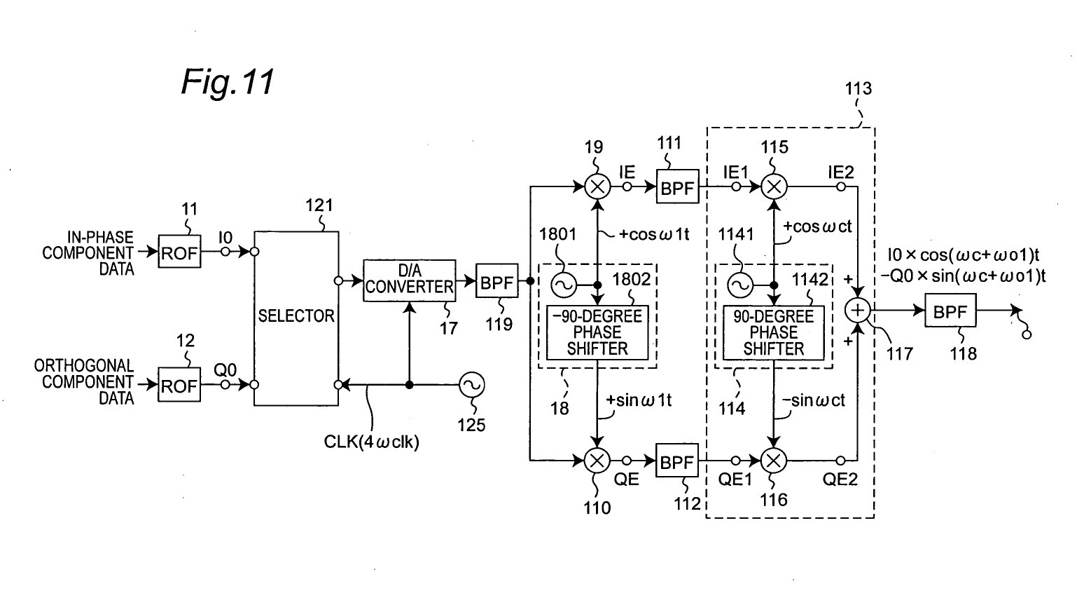

FIG. 11 is a block diagram showing a configuration of a digital quadrature modulation circuit according to a fifth preferred embodiment of the present invention. In FIG. 11, the digital quadrature modulation circuit according to the present preferred embodiment differs from that according to the first preferred embodiment of FIG. 1 in that a selector 121 is provided in place of the mixers 14 and 15, the local oscillation signal generator 13 and the adder 16 of FIG. 1, and that a clock signal generator circuit 125 is added. In other respects, since the digital quadrature modulation circuit according to the present preferred embodiment is similar to the digital quadrature modulation circuit according to the first preferred embodiment, the detailed description of the components denoted by the same reference numerals as those of FIG. 1 will be omitted

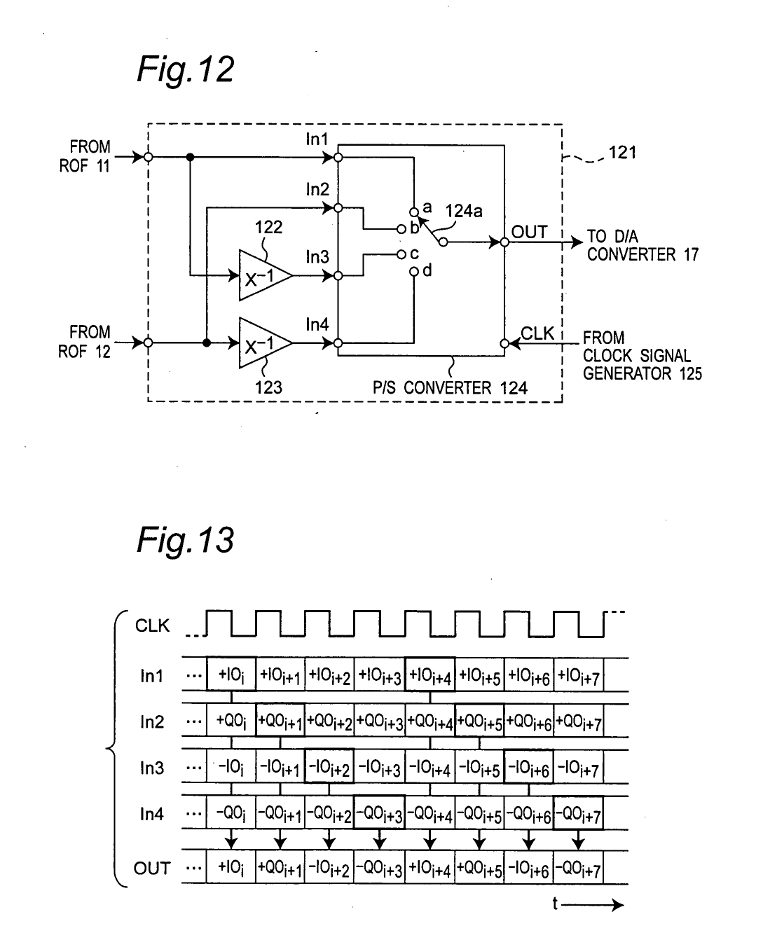

FIG. 12 is a circuit diagram showing one example of a detailed configuration of the selector 121 of FIG. 11. Referring to FIG. 12, the selector 121 is configured to include sign inverters 122 and 123 and a four-input one-output parallel/serial converter (hereinafter referred to as a P/S converter) 124. The P/S converter 124 outputs an output signal of an ROF 11 via an input terminal In1 when a switch 124a selects a contact “a”, and outputs an output signal of an ROF 12 via an input terminal In2 when the switch 124a selects a contact “b”. Further, the P/S converter 124 outputs the output signal of the ROF 11 via an input terminal In3 and the sign inverter 122 when the switch 124a selects a contact “c”, and outputs the output signal of the ROF 12 via an input terminal In4 and the sign inverter 123 when the switch 124a selects a contact “d”. The switch 124a sequentially selects one of the contacts “a”, “b”, “c” and “d” based on a clock signal CLK inputted from the clock signal generator circuit 125, and outputs the signal inputted via the selected contact to the D/A converter 17.

FIG. 13 is a waveform diagram showing operations of the respective signals in the selector 121 of FIG. 12. Referring to FIG. 13, the signals inputted via the respective input terminals In1, In2, In3 and In4 are sequentially outputted from an output terminal OUT at time intervals of a time period of the clock signal CLK.

The operation performed by the digital quadrature modulation circuit including the above-stated configurations will be described.

First of all, output signals I0 and Q0 obtained by causing the ROFs 11 and 12 to wave-shape in-phase component data and orthogonal component data, respectively, are inputted to the selector 121, and the selector 121 sequentially outputs signals I0, Q0, −I0 and −Q0 synchronously with the clock signal CLK having a frequency of 4ωclk from clock signal generator circuit 125. The D/A converter 17 converts the signals inputted from the selector 121 synchronously with the clock signal CLK from the clock signal generator circuit 125 into analog voltages, and outputs the analog voltages. An output signal IQ0 of the D/A converter 17 is expressed by the following Equation (49):
IQ0=I0×cos ωclkt+Q0×sin ωclkt (49).

Further, output signals IE and QE of mixers 19 and 110 are expressed by the following Equations (50) and (51), respectively:

$$\begin{matrix}IE = \{ \begin{matrix}I 0 \times cos ( ω clk + ω 1 ) t + \\ Q 0 \times sin ( ω clk + ω 1 ) t\end{matrix} \} / 2 + \{ \begin{matrix}I 0 \times cos ( ω clk - ω 1 ) t + \\ Q 0 \times sin ( ω clk - ω 1 ) t\end{matrix} \} / 2 ; \\ and & ( 50 ) \\ QE = \{ \begin{matrix}I 0 \times sin ( ω clk + ω 1 ) t - \\ Q 0 \times cos ( ω clk + ω 1 ) t\end{matrix} \} / 2 - \{ \begin{matrix}I 0 \times sin ( ω clk - ω 1 ) t - \\ Q 0 \times cos ( ω clk - ω 1 ) t\end{matrix} \} / 2. & ( 51 )\end{matrix}$$

BPFs 111 and 112 band-pass filter the respective output signals IE and QE to eliminate a frequency component of (ωclk+ω1) and to extract required frequency components, and output signals IE1 and QE1 to mixers 115 and 116, respectively. The output signals IE1 and QE1 of the respective BPFs 111 and 112 are expressed by the following Equations (52) and (53):

$$\begin{matrix}IE 1 = \{ I 0 \times cos ( ω clk - ω 1 ) t + Q 0 \times sin ( ω clk - ω 1 ) t \} / 2 ; \\ and & ( 52 ) \\ QE 1 = - \{ I 0 \times sin ( ω clk - ω 1 ) t - Q 0 \times cos ( ω clk - ω 1 ) t \} / 2. & ( 53 )\end{matrix}$$

The mixers 115 and 116 multiply the output signals IE1 and QE1 of the BPFs 111 and 112 by the carrier signals +cos ωct and −sin ωct from a carrier signal generator circuit 114 to mix the output signals IE1 and QE1 with the carrier signals +cos ωct and −sin ωct, respectively, and output mixture frequency-converted signals IE2 and QE2, respectively. The output signals IE2 and QE2 of the mixers 115 and 116 are expressed by the following Equations (54) and (55), respectively. The adder 117 adds up the output signals IE2 and QE2, and outputs a resultant signal to the BPF 118. The output signal (IE2+QE2) of the adder 117 is expressed by the following Equation (56), and an orthogonally modulated signal at a fundamental frequency of (ωc−ωo1) is obtained. In this case, a frequency (ωclk−ω1) is equal to ωo1:

$$\begin{matrix}IE 2 = [ \{ I 0 \times \begin{matrix}\{ \begin{matrix}cos ( ω c + ω o 1 ) t + \\ cos ( ω c - ω o 1 ) t\end{matrix} \} + \\ Q 0 \times \{ \begin{matrix}sin ( ω c + ω o 1 ) t - \\ sin ( ω c - ω o 1 ) t\end{matrix} \}\end{matrix} ] / 4 ; & ( 54 ) \\ QE 2 = [ \{ - I 0 \times \begin{matrix}\{ \begin{matrix}cos ( ω c + ω o 1 ) t + \\ cos ( ω c - ω o 1 ) t\end{matrix} \} - \\ Q 0 \times \{ \begin{matrix}sin ( ω c + ω o 1 ) t + \\ sin ( ω c - ω o 1 ) t\end{matrix} \}\end{matrix} ] / 4 ; \\ and & ( 55 ) \\ IE 2 + QE 2 = \begin{matrix}I 0 \times \{ cos ( ω c - ω o 1 ) t \} / 2 - \\ Q 0 \times \{ cos ( ω c - ω o 1 ) t \} / 2.\end{matrix} & ( 56 )\end{matrix}$$

If the frequency ωclk is equal to the frequency ω1, that is, ωo1=0, no image frequency is present. Therefore, similarly to the digital quadrature modulation circuit according to the first preferred embodiment, the filter 118 can be omitted.

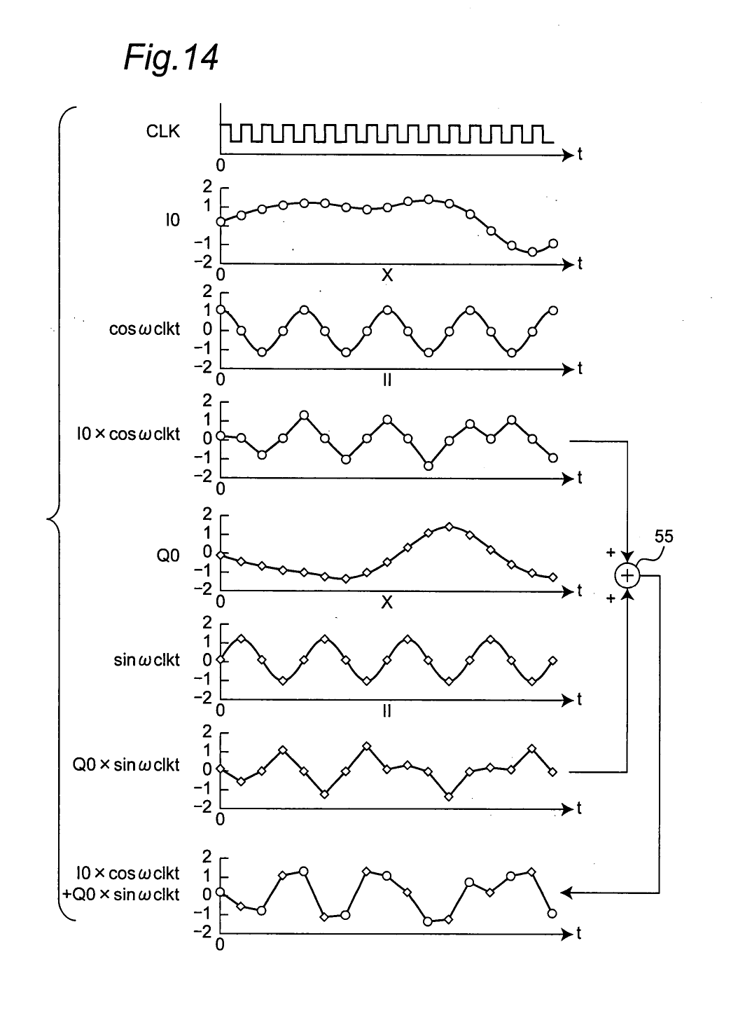

FIG. 14 is a waveform diagram showing the signals of respective parts of the selector 121 of FIG. 12. If it is assumed that a frequency of the clock signal CLK is fclk [Hz], the output signal of the selector 121 is substantially equivalent to a signal of (I0×cos ωclkt+Q0×sin ωclkt). It is to be noted that a frequency ωclk is 2πfclk/4.

When the clock signal CLK rises at a timing t=0, a value of cos ωclkt at each rising timing of the clock signal CLK changes like [+1, 0, −1, 0, +1, 0, −1, 0, . . . ], and a value of sin ωclkt at each rising timing of the clock signal CLK changes like [0, +1, 0, −1, 0, +1, 0, −1, . . . ]. Assuming that a value of the output signal I0 of the ROF 11 is [I0₀, I0₁, I0₂, I0₃, . . . ] and that a value of the output signal Q0 of the ROF 12 is [Q0₀, Q0₁, Q0₂, Q0₃, . . . ], then the signal I0×cos ωclkt is [+I0₀, 0, −I0₂, 0 . . . ], and the signal Q0×sin ωclkt is [0, +Q0₁, 0, −Q0₃, 0, . . . ]. Therefore, it can be understood that multiplication of arbitrary data by a trigonometric function can be realized by simple sign inversion. Further, when one of the signals (I0×cos ωclkt) and (Q0×sin ωclkt) is a positive or negative value, the other signal is zero. Therefore, a result of addition of the signals (I0×cos ωclkt) and (Q0×sin ωclkt), (I0×cos ωclkt+Q0×sin ωclkt) can be realized by simple selection.

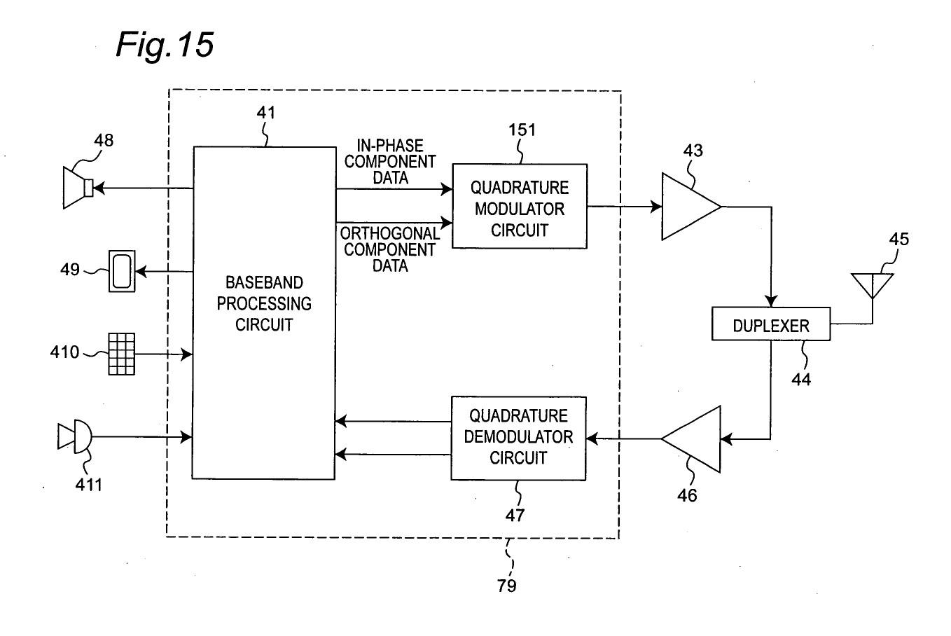

FIG. 15 is a block diagram showing a configuration of a digital communication apparatus including a digital quadrature modulation circuit 151 of FIG. 11. The digital communication apparatus of FIG. 15 differs from that according to the first preferred embodiment of FIG. 2 in that the digital quadrature modulation circuit 151 is provided in place of the digital quadrature modulation circuit 42 of FIG. 2. In other respects, since the digital communication apparatus according to the present preferred embodiment is similar to the digital communication apparatus according to the first preferred embodiment, the detailed description of the components denoted by the same reference numerals as those of FIG. 2 will be omitted. A baseband processing circuit 41, the digital quadrature modulation circuit 151 and a digital orthogonal demodulator circuit 72 are formed on one IC chip 79.

As stated above, the digital quadrature modulation circuit according to the present preferred embodiment performs the multiplication processing in a digital region before the D/A conversion is performed by sign inversion and selection using the selector 121. Therefore, the digital quadrature modulation circuit according to the present preferred embodiment can make the circuit scale small and further reduce the electric power consumption as compared with the digital quadrature modulation circuit according to the first preferred embodiment. This leads to that a radio terminal which can ensure longer conversation time and longer waiting time can be provided.

In addition, in the present preferred embodiment, the BPFs 111 and 112 band-pass filter the angular signals from the mixers 19 and 110 to eliminate the frequency component (ωclk+ω1) and to extract the required frequency components, respectively. However, the present invention is limited to the configuration according to the present preferred embodiment. The BPFs 111 and 112 may band-pass filter the angular signals from the mixers 19 and 110 to eliminate the frequency component (ωclk−ω1) and to extract the required frequency components, respectively. In this case, the present preferred embodiment can realize the same advantages as those of the digital quadrature modulation circuit according to the second preferred embodiment with a smaller circuit scale than that according to the second preferred embodiment.

Further, if the frequencies of the local oscillation signals generated by the local oscillation signal generators 1801 and 1141 and filter frequency characteristics of the BPFs 111, 112 and 119 are changed, the present preferred embodiment can realize the same advantages as those of the digital quadrature modulation circuit according to the third preferred embodiment of FIG. 5 with a smaller circuit scale that according to the third preferred embodiment. Further, the configuration of the digital quadrature modulation circuit according to the present preferred embodiment may be applied to the fourth preferred embodiment.

### Sixth Preferred Embodiment

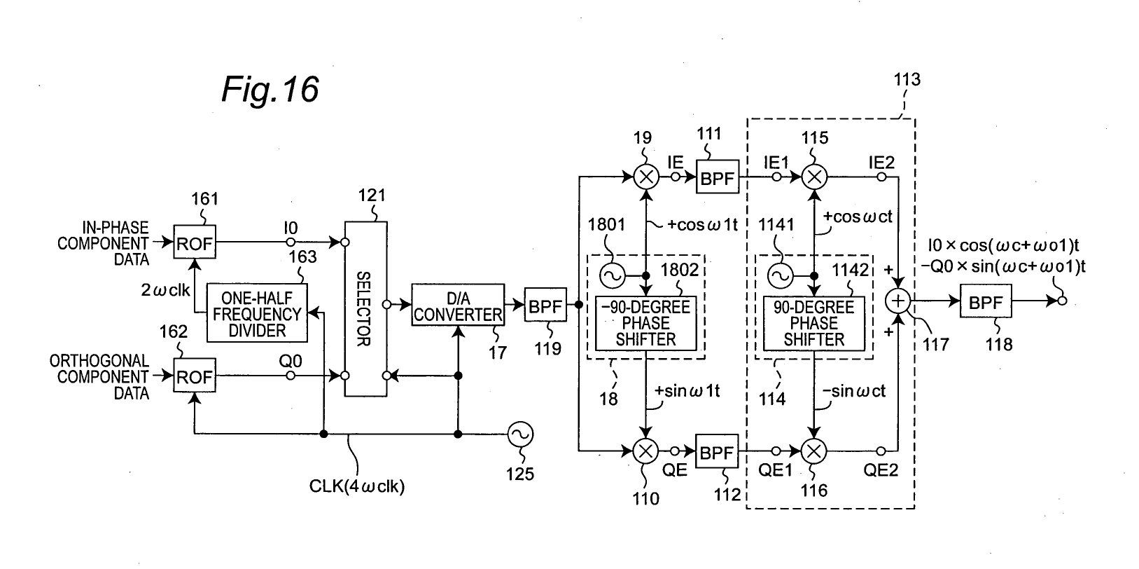

FIG. 16 is a block diagram showing a configuration of a digital quadrature modulation circuit according to a sixth preferred embodiment of the present invention. In FIG. 16, the digital quadrature modulation circuit according to the present preferred embodiment differs from that according to the fifth preferred embodiment of FIG. 11 in that ROFs 161 and 162 are provided in place of the ROFs 11 and 12, and that a one-half frequency divider 163 is added. In other respects, since the digital quadrature modulation circuit according to the present preferred embodiment is similar to the digital quadrature modulation circuit according to the fifth preferred embodiment, the detailed description of the components denoted by the same reference numerals as those of FIG. 11 will be omitted.

The ROF 162 digitally limits the band of in-phase component data inputted synchronously with a clock signal CLK (having a frequency of 2ωclk) generated by a clock signal generator circuit 125, and outputs the band-limited in-phase component data to the selector 121. The ROF 161 digitally limits the band of the orthogonal component data inputted synchronously with a clock signal CLK having the frequency of 2ωclk obtained by causing the one-half frequency divider 163 to halve the clock signal generated by the clock signal generator circuit 125, and outputs the band-limited orthogonal component data to the selector 121.

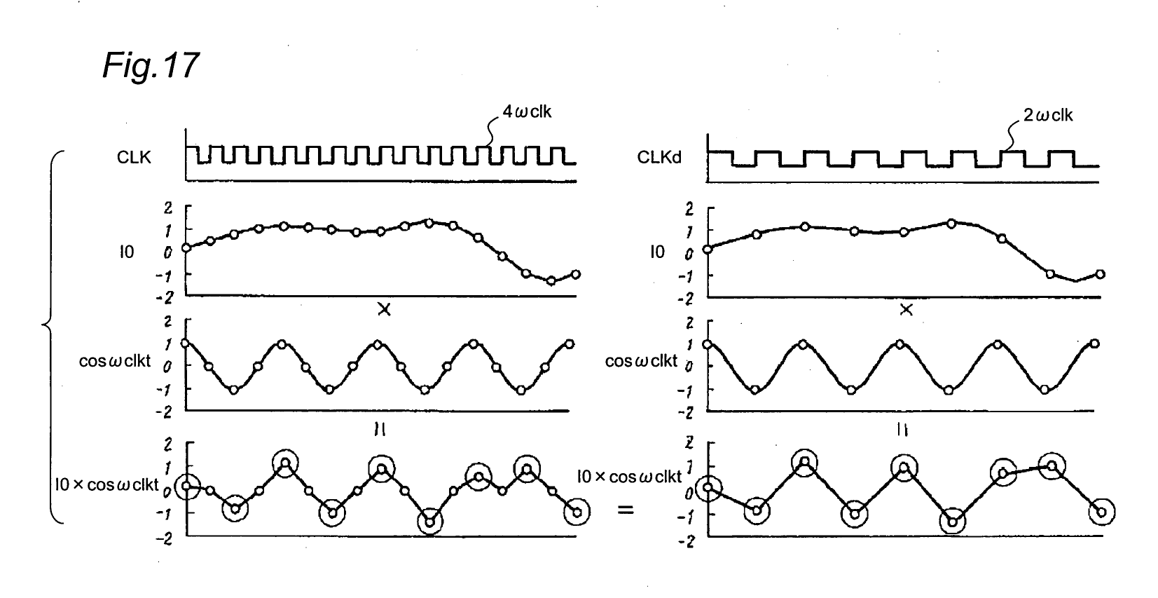

Compared with FIG. 14 showing the signals of the respective parts of the selector 121 according to the fifth preferred embodiment, the signal (I0×cos ωclkt) obtained by the processing performed by the selector 121 is zero for every other sample and its significant sample rate is half of an apparent sample rate. Therefore, it can be understood that even if the clock frequency applied to the ROF 161 is halved by the one-half frequency divider 163, the digital quadrature modulation circuit according to the present preferred embodiment exhibits the same result as that according to the fifth preferred embodiment. FIG. 17 is a waveform diagram showing signals of respective parts of the selector 121 of FIG. 16. As shown in FIG. 17, even if the ROF 161 samples the in-phase component data using a clock signal CLKd at a half frequency of that of the clock signal CLK generated by the clock signal generator circuit 125, a signal (I0×cos ωclkt) substantially equivalent to the signal (I0×cos ωclkt) of FIG. 14 can be obtained.

As stated above, the digital quadrature modulation circuit according to the present preferred embodiment sets the clock frequency of the ROF 161 half using the one-half frequency divider 163, and this leads to that the digital quadrature modulation circuit can make the circuit scale small and further reduce the electric power consumption. This leads to that a radio terminal which can ensure longer conversation time and longer waiting time can be provided.

In addition, in the present preferred embodiment, the one-half frequency divider 163 is connected to the ROF 161 to which the in-phase component data is inputted. However, the present invention is not limited to the configuration of the present preferred embodiment. Alternatively, the one-half frequency divider 163 may be connected to the ROF 162 to which the orthogonal component data is input, and at least one of the clock frequency for the ROFs 161 and 162 can be halved.

### Seventh Preferred Embodiment

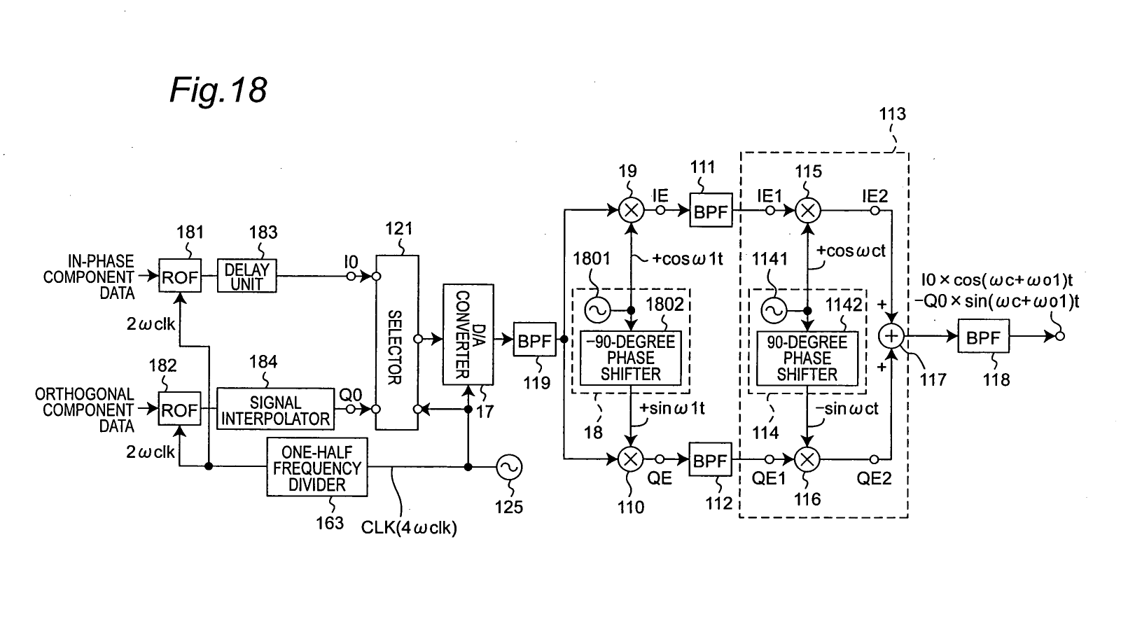

FIG. 18 is a block diagram showing a configuration of a digital quadrature modulation circuit according to a seventh preferred embodiment of the present invention. In FIG. 18, the digital quadrature modulation circuit according to the present preferred embodiment differs from that according to the fifth preferred embodiment of FIG. 11 in that ROFs 181 and 182 are provided in place of the ROFs 11 and 12, and that a one-half frequency divider 163, a delay unit 183 and a signal interpolator 184 are added. In other respects, since the digital quadrature modulation circuit according to the present preferred embodiment is similar to the digital quadrature modulation circuit according to the fifth preferred embodiment, the detailed description of the components denoted by the same reference numerals as those of FIG. 11 will be omitted.

The ROFs 181 and 182 digitally limit the bands of the in-phase component data and orthogonal component data inputted synchronously with a clock signal having a frequency of 2ωclk obtained by causing the one-half divider 163 to halve a clock signal CLK generated by a clock signal generator circuit 125, and output the band-limited in-phase component data and the band-limited orthogonal component data to the delay unit 183 and the signal interpolator 184, respectively. The signal interpolator 184 interpolates a signal outputted from the ROF 182 so as to double a clock frequency of the ROF 182 in a pseudo manner by, for example, adding two continuous values and dividing an addition result by 2, and outputs the interpolated signal to a selector 121. The delay unit 183 delays a signal outputted from the ROF 181 by predetermined time so as to adjust timing of the signal outputted from the ROF 181 to timing of the output signal of the signal interpolator 184, and outputs the delayed signal to the selector 121.

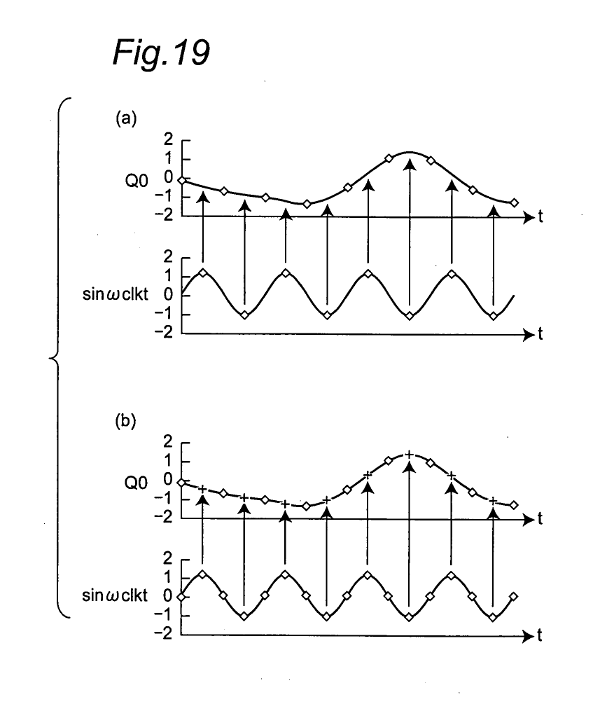

FIG. 19(a) is a waveform diagram of an output signal Q0 of the ROF 182 and a signal sin ωclkt substantially equivalent to a signal subjected to multiplication by the selector 121 when the signal interpolator 184 is not provided. FIG. 19(b) is a waveform diagram of the output signal Q0 of the signal interpolator 184 and the signal sin ωclkt substantially equivalent to the signal subjected to multiplication by the selector 121 when the signal interpolator 184 is provided. As shown in FIG. 19(a), if the signal interpolator 184 is not provided and a frequency of a clock applied to each of the ROFs 181 and 182 is set to half by the one-half frequency divider 163, data corresponding to the output signal of the ROF 182 is not present at timing of sampling based on the signal sin ωclkt. On the other hand, as shown in FIG. 19(b), if the signal interpolator 184 is provided, corresponding data is obtained even at the timing of sampling by the signal interpolator 184, and therefore, the output signal equivalent to that if the frequency of the clock is not set to half.

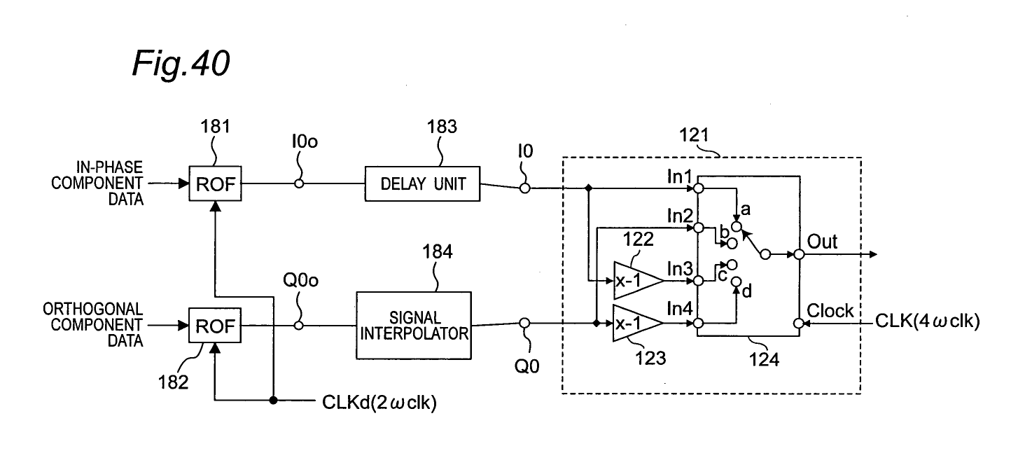

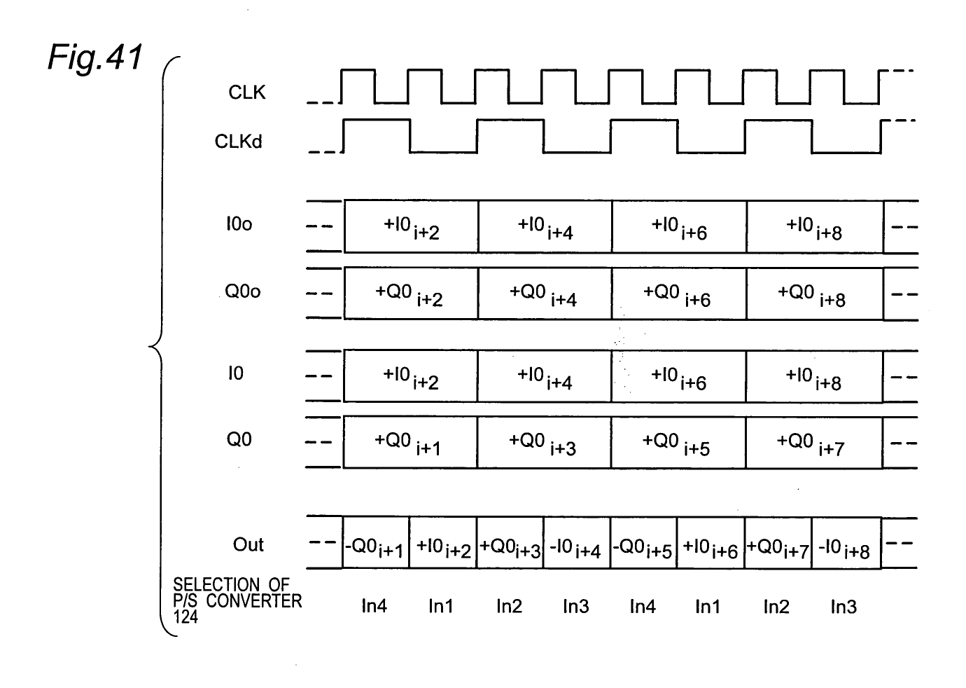

FIG. 40 is a circuit diagram showing the selector 121 and circuits arranged in front of the selector 121 according to the seventh preferred embodiment. FIG. 41 is a waveform diagram showing operations of signals related to the selector 121 of FIG. 40. Referring to FIG. 40, input terminals In1, In2, In3 and In4 of the P/S converter 124 are sequentially selected at time intervals of time period of the clock CLK, and an output signal is outputted from an output terminal OUT thereof. In the waveform diagram of FIG. 41, a delay amount of the delay unit 183 is assumed as zero for the sake of description. It is also assumed that the signal interpolator 184 obtains data corresponding to an intermediary between two continuous samples in a pseudo manner by averaging the two continuous samples. By configuring the selector 121 as described above, the output equivalent to that having the configuration according to the prior arts is obtained. In addition, it is required to set the delay amount of the delay 183 to be equal to or greater than 1 so as to improve accuracy if the signal interpolation processing is performed using three or more samples.

As stated above, the digital quadrature modulation circuit according to the present preferred embodiment is configured to include the delay unit 183 and the signal interpolator 184, causes the signal interpolator 184 to interpolate the output signal of the ROF 182, and causes the delay unit 183 to delay the output signal of the ROF 181 so as to be adjusted to the output signal of the signal interpolator 184. Therefore, it is possible to set the clock frequency for the ROFs 181 and 182 to half and to make the circuit scale smaller. This leads to that the electric power consumption can be further reduced, so that a radio terminal that can ensure longer conversation time and longer waiting time can be provided.

In addition, in the present preferred embodiment, the signal interpolator 184 interpolates the output signal of the ROF 182 and the delay unit 183 delays the output signal of the ROF 181. However, the present invention is not limited to the configuration according to the present preferred embodiment. Alternatively, the signal interpolator 184 may interpolate the output signal of the ROF 181 and the delay unit 183 may delay the output signal of the ROF 182.

### Eighth Preferred Embodiment

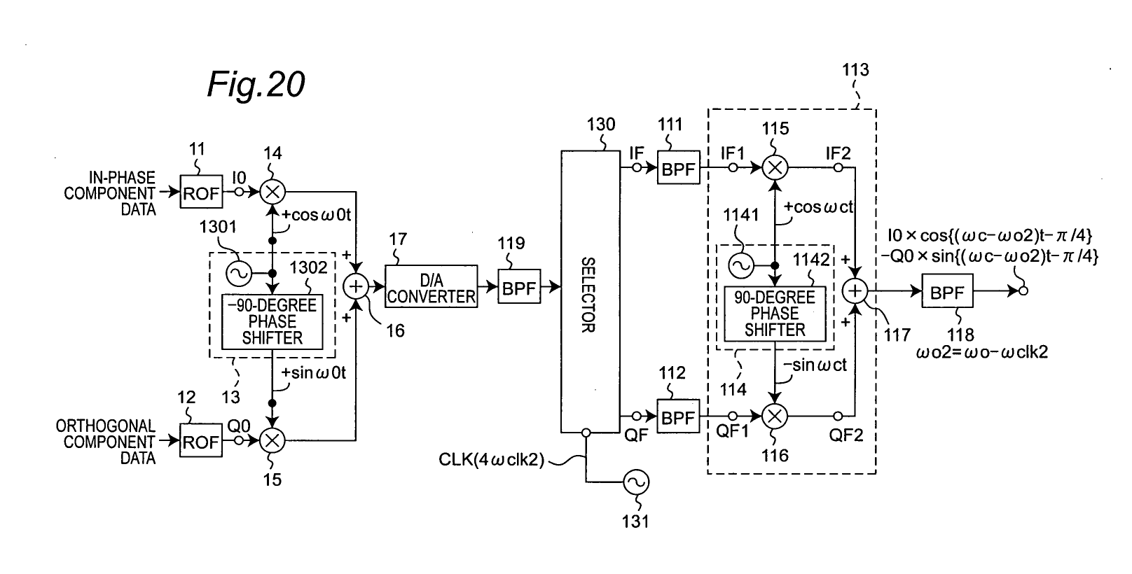

FIG. 20 is a block diagram showing a configuration of a digital quadrature modulation circuit according to an eighth preferred embodiment of the present invention. In FIG. 20, the digital quadrature modulation circuit according to the present preferred embodiment differs from that according to the first embodiment of FIG. 1 in that a selector 130 is provided in place of the mixers 19 and 110 and the local oscillation signal generator circuit 18 of FIG. 1, and that a clock signal generator circuit 131 is added. In other respects, since the digital quadrature modulation circuit according to the present preferred embodiment is similar to the digital quadrature modulation circuit according to the first preferred embodiment, the detailed description of the components denoted by the same reference numerals as those of FIG. 1 will be omitted.

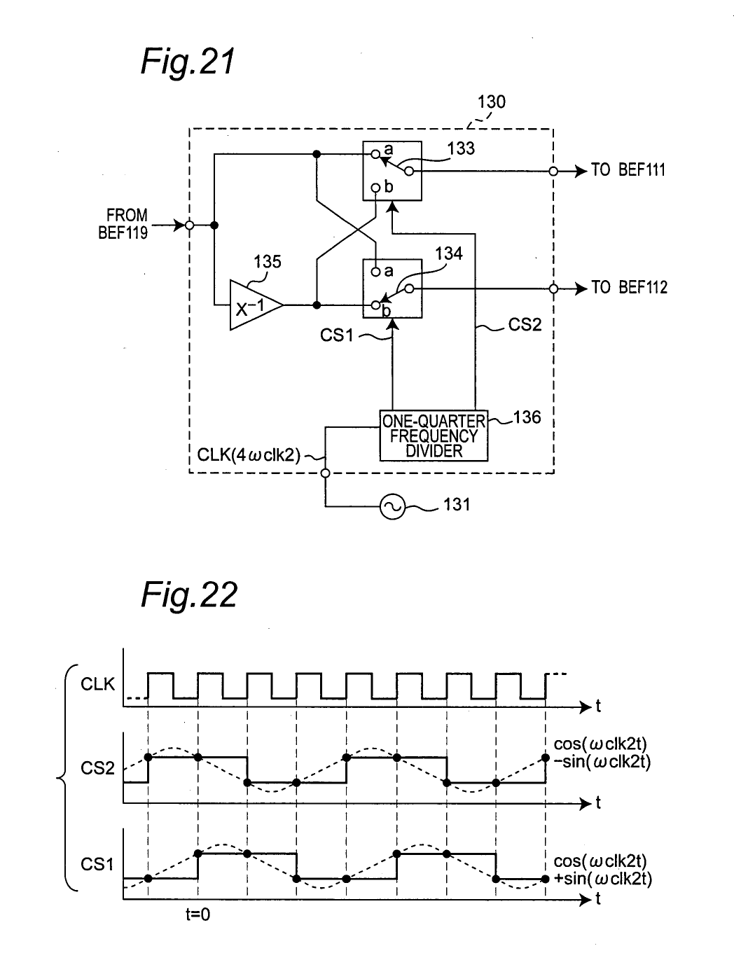

FIG. 21 is a circuit diagram showing one example of a detailed configuration of the selector 130 of FIG. 20. Referring to FIG. 21, the selector 130 is configured to include switches 133 and 134, a sign inverter 135 and a one-quarter frequency divider 136. The one-quarter frequency divider 136 is, for example, a one-quarter frequency division flip-flop circuit, and divides a clock signal CLK having a frequency of 4ωclk2 from the clock signal generator 131 by four, and outputs control signals CS1 and CS2 having a frequency of ωclk2 and orthogonal to each other. The switches 133 and 134 are controlled according to the respective control signals CS2 and CS1. The switch 133 outputs the output signal of the BPF 119 to the BPF 111 via a contact “a” when the control signal CS2 has a high level, and outputs the output signal of the BPF 119 to the BPF 111 via a contact “b” and the sign inverter 135 when the control signal CS2 has a low level. The switch 134 outputs the output signal of the BPF 119 to the BPF 112 via a contact “a” when the control signal CS1 has the high level, and outputs the output signal of the BPF 119 to the BPF 112 via a contact “b” and the sign inverter 135 when the control signal CS1 has the low level. In addition, the one-quarter frequency divider 136 has been described as one example of the circuit that generates the orthogonal control signals. However, the present invention is not limited to this. As described later in detail, the one-quarter frequency divider 136 may be replaced by a one-half frequency division flip-flop circuit or an RC phase shifter.

FIG. 22 is a waveform diagram showing operation performed by the one-quarter frequency divider 136 of FIG. 21. Referring to FIG. 22, the one-quarter frequency divider 136 divides the input clock signal CLK by four and outputs the control signals CS1 and CS2 orthogonal to each other. When a phase relationship as shown in FIG. 22 is held between the control signals CS1 and CS2, it is possible to consider that the control signal CS2 is substantially equivalent to a signal (cos ωclk2t−sin ωclk2t) and that the control signal CS1 is substantially equivalent to a signal (cos ωclk2t+sin ωclk2t) in a digital region which operates at discrete time.

The operation performed by the digital quadrature modulation circuit including the above-stated configurations will be described with reference to FIG. 20. The digital quadrature modulation circuit according to the present preferred embodiment operates similarly to that according to the first preferred embodiment up to the BPF 119. Therefore, description of the operations up to that performed by the BPF 119 will be omitted.

If a voltage applied to the selector 130 is Vda expressed by the following Equation (57), output signals IF and QF of the selector 130 are expressed by the following Equations (58) and (59), respectively:

$$\begin{matrix}Vda = ( I 0 \times cos ω 0 t + Q 0 \times sin ω 0 t ) ; & ( 57 ) \\ \begin{matrix}IF = Vda \times ( cos ω clk 2 t - sin ω clk 2 t ) \\ = \{ \begin{matrix}( I 0 + Q 0 ) \times cos ( ω 0 + ω clk 2 ) t - \\ ( I 0 - Q 0 ) \times sin ( ω 0 - ω clk 2 ) t\end{matrix} \} / 2 + \\ \{ \begin{matrix}( I 0 - Q 0 ) \times cos ( ω 0 - ω clk 2 ) t + \\ ( I 0 + Q 0 ) \times sin ( ω 0 - ω clk 2 ) t\end{matrix} \} / 2 ;\end{matrix} \\ and & ( 58 ) \\ \begin{matrix}QF = Vda \times ( cos ω clk 2 t + sin ω clk 2 t ) \\ = \{ \begin{matrix}( I 0 - Q 0 ) \times cos ( ω 0 + ω clk 2 ) t + \\ ( I 0 + Q 0 ) \times sin ( ω 0 + ω clk 2 ) t\end{matrix} \} / 2 + \\ \{ \begin{matrix}( I 0 + Q 0 ) \times cos ( ω 0 - ω clk 2 ) t - \\ ( I 0 - Q 0 ) \times sin ( ω 0 - ω clk 2 ) t\end{matrix} \} / 2.\end{matrix} & ( 59 )\end{matrix}$$

The BPFs 111 and 112 band-pass filter the output signals IF and QF to eliminate a frequency component (ω0+ωclk2) from the output signals IF and QF and to extract required frequency components, and output signals to the mixers 115 and 116, respectively. The output signals IF1 and QF1 of the BPFs 111 and 112 are expressed by the following Equations (60) and (61), respectively. The frequency (ω0−ωclk2) is equal to ωo2:

$$\begin{matrix}\begin{matrix}IF 1 = \{ \begin{matrix}( I 0 - Q 0 ) \times cos ( ω 0 - ω clk 2 ) t + \\ ( I 0 + Q 0 ) \times sin ( ω 0 - ω clk 2 ) t\end{matrix} \} / 2 \\ = \{ \begin{matrix}I 0 \times sin ( ω o2 t + Π / 4 ) - \\ Q 0 \times cos ( ω o 2 t + Π / 4 )\end{matrix} \} / \sqrt{2} ;\end{matrix} \\ and & ( 60 ) \\ \begin{matrix}QF 1 = \{ \begin{matrix}( I 0 + Q 0 ) \times cos ( ω 0 - ω clk 2 ) t - \\ ( I 0 - Q 0 ) \times sin ( ω 0 - ω clk 2 ) t\end{matrix} \} / 2 \\ = \{ \begin{matrix}I 0 \times cos ( ω o2 t + Π / 4 ) - \\ Q 0 \times sin ( ω o 2 t + Π / 4 )\end{matrix} \} / \sqrt{2} .\end{matrix} & ( 61 )\end{matrix}$$

Next, the image-suppression frequency converter 113 processes the output signals IF1 and QF1 similarly to the image-suppression frequency converter 113 in the digital quadrature modulation circuit according to the first preferred embodiment. Output signals IF2 and QF2 of the mixers 115 and 116 are expressed by the following Equations (62) and (63), respectively. An output signal of the image-suppression frequency converter 113 is expressed by the following Equation (64). An orthogonally modulated signal at a fundamental frequency of (ωc−ωo2) is obtained. In addition, when a frequency ω0 is equal to the frequency of ωclk2, that is, ωo2=0, since no image frequency is present, the BPF 118 can be omitted:

$$\begin{matrix}IF 2 = [ I 0 \times [ sin \{ ( ω c + ω o 2 ) t + π / 4 \} - sin \{ ( ω c - ω o 2 ) t - π / 4 \} ] - Q 0 \times [ cos \{ ( ω c + ω o 2 ) t + π / 4 \} + cos \{ ( ω c - ω o 2 ) t - π / 4 \} ] ] / ( 2 \sqrt{2} ) ; & ( 62 ) \\ QF 2 = [ - I 0 \times [ sin \{ ( ω c + ω o 2 ) t + π / 4 \} + sin \{ ( ω c - ω o 2 ) t - π / 4 \} ] + Q 0 \times [ cos \{ ( ω c + ω o 2 ) t + π / 4 \} - cos \{ ( ω c - ω o 2 ) t - π / 4 \} ] ] / ( 2 \sqrt{2} ) ; \\ and & ( 63 ) \\ \begin{matrix} IF 2 + QF 2 = [ \begin{matrix}- I 0 \times sin \{ ( ω c - ω o 2 ) t - π / 4 \} - \\ Q 0 \times cos \{ ( ω c - ω o 2 ) t - π / 4 \}\end{matrix} ] / \sqrt{2} \\ = [ \begin{matrix}I 0 \times cos \{ ( ω c - ω o 2 ) t + π / 4 \} - \\ Q 0 \times sin \{ ( ω c - ω o 2 ) t + π / 4 \}\end{matrix} ] / \sqrt{2.}\end{matrix} & ( 64 )\end{matrix}$$

As stated above, according to the digital quadrature modulation circuit according to the present preferred embodiment, multiplication processing in an analog region after the D/A conversion is performed by signal inversion and selection using the selector 130. Therefore, the digital quadrature modulation circuit according to the present preferred embodiment can make the circuit scale small and further reduce the electric power consumption as compared with the digital quadrature modulation circuit according to the first preferred embodiment. This leads to that a radio terminal which can ensure longer conversation time and longer waiting time can be provided.

### Ninth Preferred Embodiment

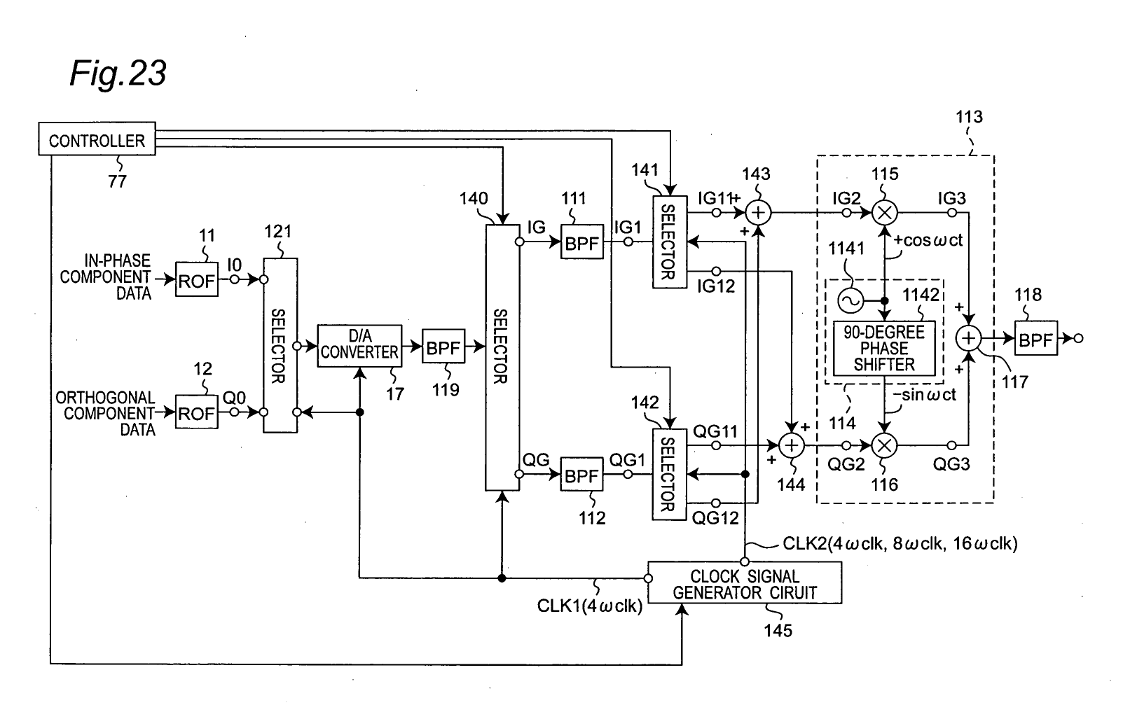

FIG. 23 is a block diagram showing a configuration of a digital quadrature modulation circuit according to a ninth preferred embodiment of the present invention. In FIG. 23, the digital quadrature modulation circuit according to the present preferred embodiment differs from the digital quadrature modulation circuit according to the fifth preferred embodiment of FIG. 11 in that a selector 140 is provided in place of the mixers 19 and 110 and the local oscillation signal generator circuit 18 of FIG. 11, that selectors 141 and 142 and adders 143 and 144 are added between BPFs 111 and 112 and the image-suppression frequency converter 113, and a clock signal generator circuit 145 is provided in place of the clock signal generator circuit 125 of FIG. 11, and that a controller 77 is added. In other respects, since the digital quadrature modulation circuit according to the present preferred embodiment is similar to the digital quadrature modulation circuit according to the fifth preferred embodiment, the detailed description of the components denoted by the same reference numerals as those of FIG. 11 will be omitted.

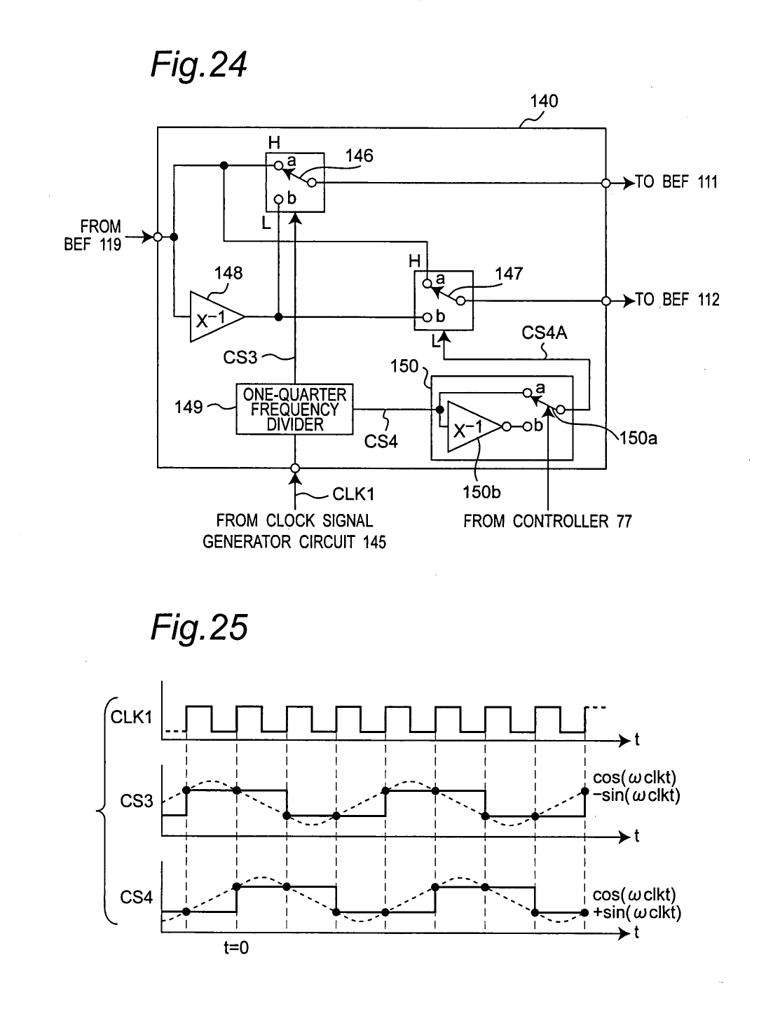

Referring to FIG. 23, the selector 140 inverts a sign of an output signal of the BPF 119 and make selection based on a clock CLK1 from the clock signal generator circuit 145, and outputs signals IG and QG (as described later in detail with reference to FIG. 24). The BPF 111 band-pass filters the output signal IG to extract a required frequency component from the output signal IG, and outputs the band-pass filtered signal to the selector 141. The BPF 112 band-pass filters the output signal QG to extract a required frequency component from the output signal QG, and outputs the band-pass filtered signal to the selector 142. The selector 141 inverts a sign of the output signal IG1 of the BPF 111 and make selection based on a clock signal CLK2 from the clock signal generator circuit 145, and outputs signals IG11 and IG12. The selector 142 inverts a sign of the output signal QG1 of the BPF 112 and make selection based on a clock signal CLK2 from the clock signal generator circuit 145, and outputs signals QG11 and QG12. The adder 143 adds up the output signals IG11 and the QG12 and outputs a resultant signal to the mixer 115. The adder 144 adds up the output signals IG12 and the QG11 and outputs a resultant signal to the mixer 116.

FIG. 24 is a block diagram showing a detailed configuration of the selector 140 of FIG. 23. Referring to FIG. 24, the selector 140 is configured to include switches 146 and 147, a sign inverter 148, a one-quarter frequency divider 149, a sign switcher 150 and a 90-degree phase shifter 155. The one-quarter frequency divider 149 is, for example, a one-quarter frequency division flip-flop circuit, and divides the clock signal CLK1 outputted from the clock signal generator circuit 145 by four, and outputs control signals CS3 and CS4 orthogonal to each other. A switch 150a of the sign switcher 150 is controlled by the controller 77. The sign switcher 150 outputs the control signal CS4 as it is, as a control signal CS4A, via a contact “a” of the switch 150a in a non-inverted mode, and outputs an inverted control signal CS4A via a sign inverter 150b and a contact “b” of the switch 150a in an inverted mode. The switches 146 and 147 are controlled according to output signals of the one-quarter frequency divider 149 and the sign switcher 150, respectively. The switch 146 outputs an output signal of the BPF 119 to the BPF 111 via a contact “a” when the control signal CS3 has the high level, and outputs the output signal of the BPF 119 to the BPF 111 via the sign inverter 148 and a contact “b” of the switch 147 when the control signal CS3 has the low level. The switch 147 outputs the output signal of the BPF 119 to the BPF 112 via a contact “a” of the switch 147 when the control signal CS4A has the high level, and outputs the output signal of the BPF 119 to the BPF 112 via the sign inverter 148 and the contact “b” of the switch 147 when the control signal CS4A has the low level. In addition, the one-quarter frequency divider 149 is a one-quarter frequency division flip-flop circuit. However, the present invention is not limited to this. The one-quarter frequency divider 149 may be a one-half frequency division flip-flop circuit or an RC phase shifter. The configurations of selectors 141 and 142 of FIG. 23 are similar to the configuration of the selector 140.

FIG. 25 is a waveform diagram showing operation performed by the one-quarter frequency divider 149 of FIG. 24 and the 90-degree phase shifter 155. Referring to FIG. 25, the one-quarter frequency divider 149 divides the inputted clock signal CLK1 by four and outputs the control signal CS3. The 90-degree phase shifter 155 outputs the control signal CS4 shifted in phase from the control signal CS3 by 90 degrees. Phases of the control signals CS3 and CS4 are orthogonal to each other. As shown in FIG. 25, when a frequency of the clock signal CLK1 is 4ωclk, it is possible to consider that the control signal CS3 is substantially equivalent to a signal (cos ωclkt−sin ωclkt) and that the control signal CS4 is substantially equivalent to a signal (cos ωclkt+sin ωclkt).

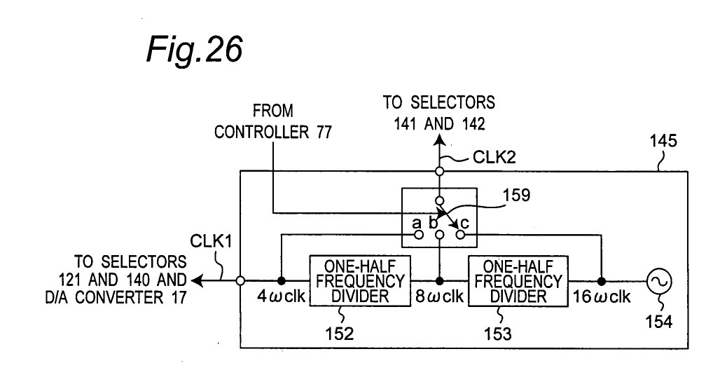

FIG. 26 is a block diagram showing a detailed configuration of the clock signal generator circuit 145 of FIG. 23. Referring to FIG. 26, the clock signal generator circuit 145 is configured to include a switch 159, one-half frequency dividers 152 and 153 and a clock signal generator 154. The clock signal generator 154 generates and outputs a signal having a frequency of 16ωclk. The one-half frequency divider 153 halves the frequency of the signal outputted from the clock signal generator 154, and generates and outputs a signal having a frequency of 8ωclk. The one-half frequency divider 152 halves the frequency of the signal outputted from the one-half frequency divider 153, generates a signal having a frequency of 4ωclk, and outputs the signal to the selectors 121 and 140 and the D/A converter 17. The switch 159 is controlled by the controller 77, outputs the signal having the frequency of 4ωclk to the selectors 141 and 142 via a contact “a”, outputs the signal having the frequency of 8ωclk to the selectors 141 and 142 via a contact “b”, and outputs the signal having the frequency of 16ωclk to the selectors 141 and 142 via a contact “c”.

The operation performed by the digital quadrature modulation circuit including the above-stated configurations will be described with reference to FIG. 23. The digital quadrature modulation circuit according to the present preferred embodiment operates similarly to that according to the fifth preferred embodiment of FIG. 11 up to the BPF 119. Therefore, the description of the operations up to that performed by the BPF 119 will be omitted.

If a voltage applied to the selector 140 is Vin expressed by the following Equation (65), output signals IG and QG of the selector 140 are expressed by the following Equations (66) and (67), respectively. It is to be noted that a coefficient decided by the mode of the sign switcher 150 in the selector 140 is “a1”, and that the coefficient “a1” is 1 in the non-inverted mode and is −1 in the inverted mode:

$$\begin{matrix}Vin = ( I 0 \times cos ω 0 t + Q 0 \times sin ω 0 t ) ; & ( 65 ) \\ \begin{matrix}IG = Vin ( cos ω clkt - sin ω clkt ) \\ = \{ \begin{matrix}( I 0 - Q 0 ) + ( I 0 + Q 0 ) \times cos ( 2 ω clk ) t - \\ ( I 0 - Q 0 ) \times sin ( 2 ω clk ) t\end{matrix} \} / 2 ;\end{matrix} \\ and & ( 66 ) \\ \begin{matrix}QG = a 1 \times Vin ( cos ω clkt + sin ω clkt ) \\ = a 1 \times \{ \begin{matrix}( I 0 + Q 0 ) + ( I 0 - Q 0 ) \times cos ( 2 ω clk ) t + \\ ( I 0 + Q 0 ) \times sin ( 2 ω clk ) t\end{matrix} \} / 2.\end{matrix} & ( 67 )\end{matrix}$$

The BPFs 111 and 112 band-pass filter the output signals IG and QG to eliminate frequency components (I0±Q0) from the output signals IG and QG and to extract required frequency components, and output signals IG1 and QG1 to the mixers 141 and 142, respectively. The output signals IG1 and QG1 of the BPFs 111 and 112 are expressed by the following Equations (68) and (69), respectively:

$$\begin{matrix}IG 1 = \{ \begin{matrix}( I 0 + Q 0 ) \times cos ( 2 ω clk ) t - \\ ( I 0 - Q 0 ) \times sin ( 2 ω clk ) t\end{matrix} \} / 2 ; \\ and & ( 68 ) \\ QG 1 = a 1 \times \{ \begin{matrix}( I 0 - Q 0 ) \times cos ( 2 ω clk ) t + \\ ( I 0 + Q 0 ) \times sin ( 2 ω clk ) t\end{matrix} \} / 2. & ( 69 )\end{matrix}$$

When a frequency of the clock signal CLK2 from the clock signal generator circuit 145 is 4ωa, the output signals IG11 and IG12 of the selector 141 and the output signals QG11 and QG12 of the selector 142 are expressed by the following Equations (70) to (73), respectively. It is to be noted that coefficients decided by the modes of the sign switchers 150 in the selectors 141 and 142 is “a2” and “a3”, respectively, and that the coefficients “a2” and “a3” are 1 in the non-inverted modes and are −1 in the inverted modes. Further, a frequency (2ωclk−ωa) is ωo3, and a frequency (2ωclk+ωa) is ωo4:

$$\begin{matrix}IG 11 = I 0 \times cos ( ω o 3 ) t + Q 0 \times sin ( ω o 3 ) t + Q 0 \times cos ( ω o 4 ) t - I 0 \times sin ( ω o 4 ) t ; & ( 70 ) \\ IG 12 = a 2 \times \{ Q 0 \times cos ( ω o 3 ) t - I 0 \times sin ( ω o 3 ) t + I 0 \times cos ( ω o 4 ) t + Q 0 \times sin ( ω o 4 ) t \} ; \\ and & ( 71 ) \\ QG 11 = a 1 \times \{ - Q 0 \times cos ( ω o 3 ) t + I 0 \times sin ( ω o 3 ) t + I 0 \times cos ( ω o 4 ) t + Q 0 \times sin ( ω o 4 ) t \} . & ( 72 ) \\ QG 12 = a 1 \times a 3 \times \{ I 0 \times cos ( ω o 3 ) t + Q 0 \times sin ( ω o 3 ) t - Q 0 \times cos ( ω o 4 ) t + I 0 \times sin ( ω o 4 ) t \} & ( 73 )\end{matrix}$$

The adder 143 adds up the output signals IG11 and QG12 and outputs the resultant signal. The adder 144 adds up the output signals IG12 and QG11 and outputs the resultant signal. The output signals of the respective adders 143 and 144 are expressed by the following Equations (74) and (75):

$$\begin{matrix}\begin{matrix}IG 2 = ( 1 + a 1 \times a 3 ) \times \{ I 0 \times cos ( ω o 3 ) t + Q 0 \times sin ( ω o 3 ) t \} + \\ ( 1 - a 1 \times a 3 ) \times \{ Q 0 \times cos ( ω o 4 ) t - I 0 \times sin ( ω o 4 ) t \} ;\end{matrix} \\ and & ( 74 ) \\ \begin{matrix}QG 2 = - ( a 1 - a 2 ) \times \{ Q 0 \times cos ( ω o 3 ) t - I 0 \times sin ( ω o 3 ) t \} + \\ ( a 1 + a 2 ) \times \{ I 0 \times cos ( ω o 4 ) t + Q 0 \times sin ( ω o 4 ) t \} .\end{matrix} & ( 75 )\end{matrix}$$

Next, the image-suppression frequency converter 113 processes the output signals IG2 and QG2 similarly to the image-suppression frequency converter 113 of the digital quadrature modulation circuit according to the first preferred embodiment. Output signals IG3 and QG3 of the mixers 115 and 116 are expressed by the following Equations (76) and (77), respectively. An output signal of the image-suppression frequency converter 113 is expressed by the following Equation (78). An orthogonally modulated signal containing four frequency components of fundamental frequencies (ωc±ωo3) and (ωc±ωo4) can be obtained. In the Equation (78), a phase offset component (3×π/2) is superimposed on a cosine component and a sine component, respectively. However, because the same phase offset component is superimposed on both of the cosine component and the sine component, orthogonality between the output signals I0 and Q0 is not influenced at all:

$$\begin{matrix}IG 3 = ( 1 + a 1 \times a 3 ) \times \{ I 0 \times cos ( ω c - ω o 3 ) t - Q 0 \times sin ( ω c - ω o 3 ) t + I 0 \times cos ( ω c + ω o 3 ) t + Q 0 \times sin ( ω c + ω o 3 ) t \} / 2 + ( 1 - a 1 \times a 3 ) \times \{ Q 0 \times cos ( ω c - ω o 4 ) t + I 0 \times sin ( ω c - ω o 4 ) t + Q 0 \times cos ( ω c + ω o 4 ) t - I 0 \times sin ( ω c + ω o 4 ) t \} / 2 ; & ( 76 ) \\ QG 3 = ( a 1 - a 2 ) \times \{ - I 0 \times cos ( ω c - ω o 3 ) t + Q 0 \times sin ( ω c - ω o 3 ) t + I 0 \times cos ( ω c + ω o 3 ) t + Q 0 \times sin ( ω c + ω o 3 ) t \} / 2 + ( a 1 + a 2 ) \times \{ Q 0 \times cos ( ω c - ω o 4 ) t + I 0 \times sin ( ω c - ω o 4 ) t - Q 0 \times cos ( ω c + ω o 4 ) t + I 0 \times sin ( ω c + ω o 4 ) t \} / 2 ; \\ and & ( 77 ) \\ \begin{matrix}IG 3 + QG 3 = ( 1 + a 1 \times a 3 - a 1 + a 2 ) \times \\ \{ I 0 \times cos ( ω c - ω o 3 ) t - Q 0 \times sin ( ω c - ω o 3 ) t \} / 2 + \\ ( 1 + a 1 \times a 3 + a 1 - a 2 ) \times \\ \{ I 0 \times cos ( ω c + ω o 3 ) t - Q 0 \times sin ( ω c - ω o 3 ) t \} / 2 + \\ ( 1 - a 1 \times a 3 + a 1 + a 2 ) \times \\ \{ Q 0 \times cos ( ω c - ω o 4 ) t + I 0 \times sin ( ω c - ω o 4 ) t \} / 2 + \\ ( 1 - a 1 \times a 3 - a 1 - a 2 ) \times \\ \{ Q 0 \times cos ( ω c + ω o 4 ) t + I 0 \times sin ( ω c + ω o 4 ) t \} / 2 \\ = ( 1 + a 1 \times a 3 - a 1 + a 2 ) \times \\ \{ I 0 \times cos ( ω c - ω o 3 ) t - Q 0 \times sin ( ω c - ω o 3 ) t \} / 2 + \\ ( 1 + a 1 \times a 3 + a 1 - a 2 ) \times \\ \{ I 0 \times cos ( ω c + ω o 3 ) t - Q 0 \times sin ( ω c + ω o 3 ) t \} / 2 + \\ ( 1 - a 1 \times a 3 + a 1 + a 2 ) \times \\ \{ I 0 \times cos \{ ( ω c - ω o 4 ) t + 3 \times π / 2 \} - \\ Q 0 \times sin \{ ( ω c - ω o 4 ) t + 3 \times π / 2 \} ] / 2 + \\ ( 1 - a 1 \times a 3 - a 1 - a 2 ) \times \\ [ \begin{matrix}I 0 \times cos \{ ( ω c + ω o 4 ) t + 3 \times π / 2 \} - \\ Q 0 \times sin \{ ( ω c + ω o 4 ) t + 3 \times π / 2 \}\end{matrix} ] / 2.\end{matrix} & ( 78 )\end{matrix}$$

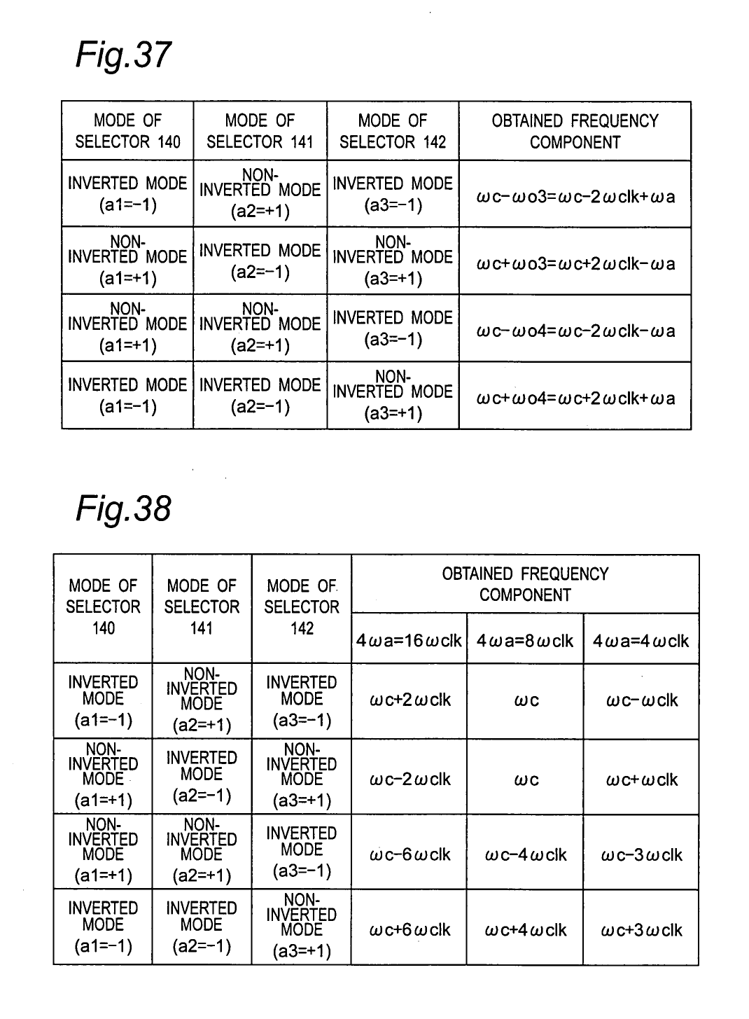

FIGS. 37 and 38 are tables showing the relationship between mode settings of the respective selectors 140, 141 and 142 and obtained frequency components. As shown in FIG. 37, when the selector 140 is set to the inverted mode, the selector 141 is set to the non-inverted mode, and the selector 142 is set to the inverted mode, a frequency component (ωc−ωo3) is obtained. When the selector 140, 141 and 142 are set to the non-inverted mode, the inverted mode and the non-inverted mode, respectively, a frequency component (ωc+ωo3) is obtained. Further, when the selector 140, 141 and 142 are set to the non-inverted mode, the non-inverted mode and the inverted mode, respectively, a frequency component (ωc−ωo4) is obtained. When the selector 140, 141 and 142 are set to the inverted mode, the inverted mode and the non-inverted mode, respectively, a frequency component (ωc+ωo4) is obtained. Therefore, by switching the modes of the selectors 140, 141 and 142, one arbitrary component can be extracted from the output signal (IG3+QG3) expressed by the Equation (78), that is, four channels can be switched over at channel intervals of 2ωclk. Further, as shown in FIG. 38, by switching the frequency 4ωa of the clock signal CLK2 generated by the clock signal generator circuit 145 using the switch 159, eleven channels can be switched over at channel intervals of ωclk or seven channels can be switched over at channel intervals of 2ωclk.

As stated above, according to the digital quadrature modulation circuit according to the present preferred embodiment, a plurality of frequencies based on different frequencies can be switched over by controlling the sign switcher 150 and the switch 159, and therefore, it is possible to shorten the time required for frequency switching.

### Tenth Preferred Embodiment

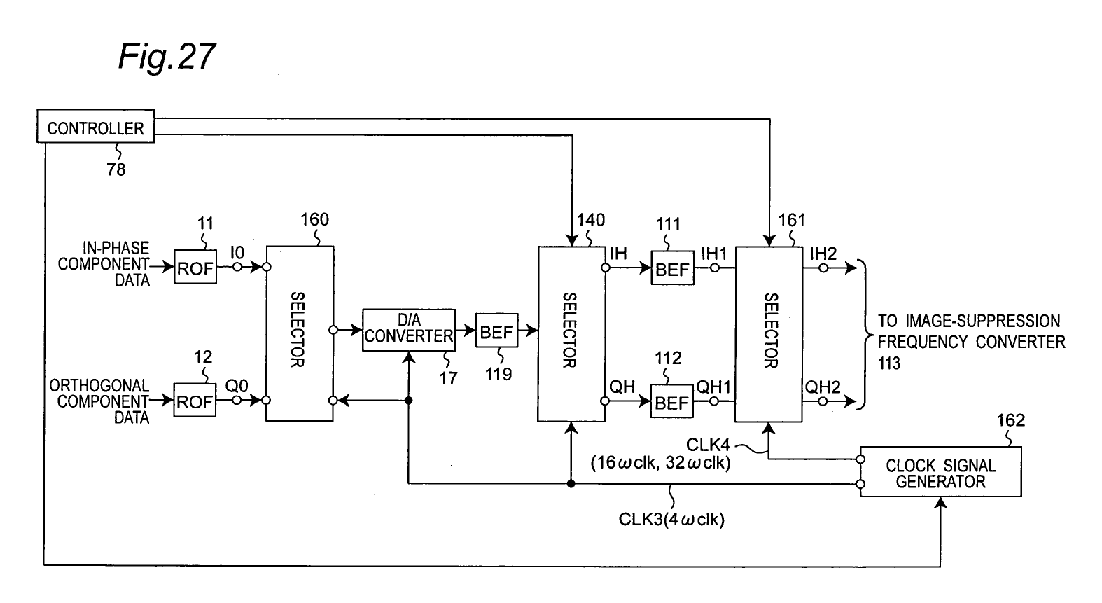

FIG. 27 is a block diagram showing a configuration of a digital quadrature modulation circuit according to a tenth preferred embodiment of the present invention. In FIG. 27, the digital quadrature modulation circuit according to the present preferred embodiment differs from the digital quadrature modulation circuit according to the ninth preferred embodiment of FIG. 23 in that a selector 160 is provided in place of the selector 121, that a selector 161 is provided in place of the selectors 141 and 142 and the adders 143 and 144, that a clock signal generator circuit 162 is provided in place of the clock signal generator circuit 145, and that a controller 78 is provided in place of the controller 77. In other respects, since the digital quadrature modulation circuit according to the present preferred embodiment is similar to the digital quadrature modulation circuit according to the ninth preferred embodiment, the detailed description of the components denoted by the same reference numerals as those of FIG. 23 will be omitted.

Referring to FIG. 27, the selector 160 inverts signs of respective output signals I0 and Q0 of ROFs 11 and 12 and makes selection based on a clock signal CLK3 from the clock signal generator circuit 162, and outputs a signal IQH to the selector 140 via the D/A converter 17 and the BPF 119. The selector 140 inverts a sign of the signal from the BPF 119 and makes selection based on the clock signal CLK3 from the clock signal generator circuit 162, and outputs signals IH and QH. The BPF 111 band-pass filters the output signal IH to extract a required frequency component, and outputs the band-pass filtered signal to the selector 161. The BPF 112 band-pass filters the output signal QH to extract a required frequency component, and outputs the band-pass filtered signal to the selector 161. The selector 161 inverts signs of the output signal IH1 and QH1 of the BPFs 111 and 112 and makes selection based on a clock signal CLK4 from the clock signal generator circuit 162, respectively, and outputs signals IH2 and QH2 to the image-suppression frequency converter 113 which is not shown.

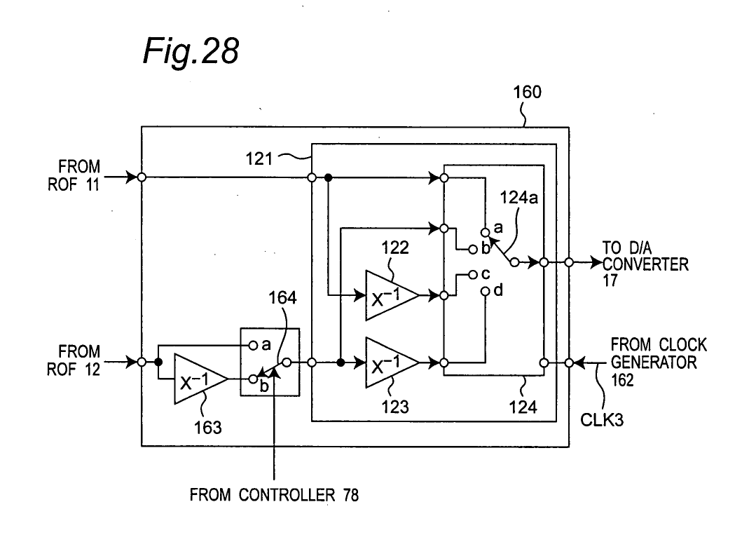

FIG. 28 is a circuit diagram showing one example of a detailed configuration of the selector 160 of FIG. 27. Referring to FIG. 28, the selector 160 is configured to include the selector 121 of FIG. 12, a sign inverter 163 and a switch 164. The switch 164, which is controlled by the controller 78, outputs the output signal of the ROF 12 to the selector 121 as it is when a contact “a” is selected, and outputs the output signal of the ROF 12 to the selector 121 via the sign inverter 163.

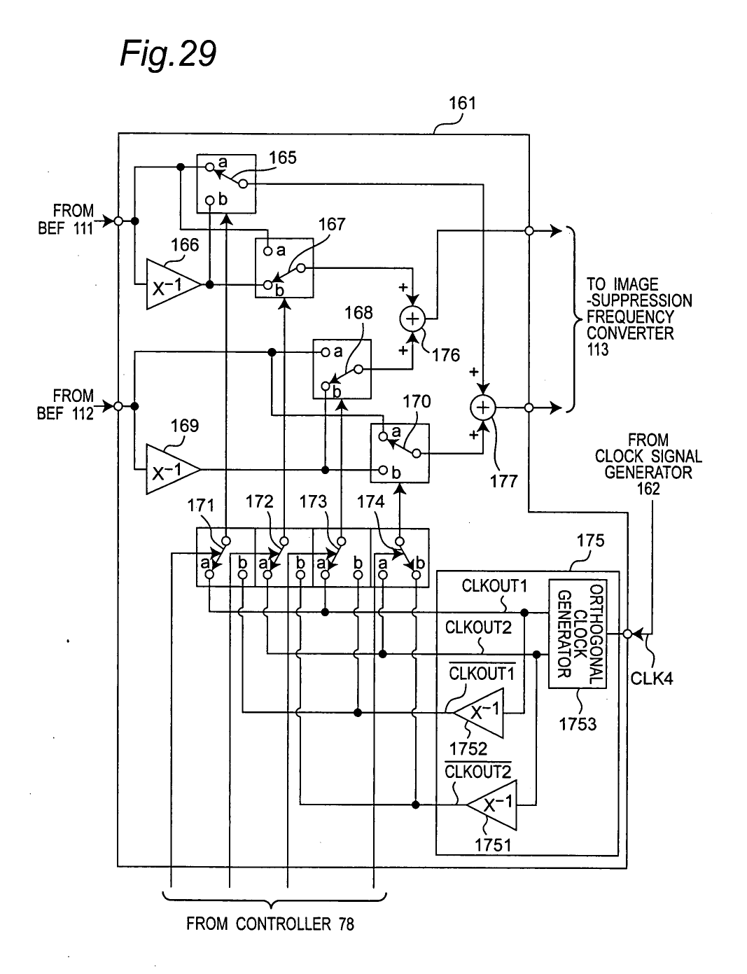

FIG. 29 is a circuit diagram showing one example of a detailed configuration of the selector 161 of FIG. 27. Referring to FIG. 29, the selector 161 is configured to include sign inverters 166 and 169, switches 165, 167, 168 and 170 to 174, a clock control circuit 175 and adders 176 and 177. The clock control circuit 175 is configured to include an orthogonal clock generator 1753 and sign inverters 1751 and 1752. The orthogonal clock generator 1753 divides the clock signal CLK4 from the clock signal generator circuit 162 by four, and outputs a first output signal and a second output signal whose phase is shifted by 90 degrees from that of the first output signal. The first output signal of the orthogonal clock generator 1753 is applied to contacts “a” of the switches 171 and 173 as a clock signal CLKOUT1, and applied to contacts “b” of the switches 171 and 173 as a clock signal C̅L̅K̅O̅U̅T̅1̅ via the sign inverter 1752. The second output signal of the orthogonal clock generator 1753 is applied to contacts “a” of the switches 172 and 174 as a clock signal CLKOUT2, and applied to contacts “b” of the switches 172 and 174 as a clock signal C̅L̅K̅O̅U̅T̅2̅ via the sign inverter 1751. The switches 171 to 174 are controlled by the controller 78. The switches 165, 167, 168 and 170 are controlled by signals inputted via the switches 171 to 174, respectively. The switch 165 outputs the output signal of the BPF 111 to the adder 177 via a contact “a” when the input signal has the high level, and outputs the output signal of the BPF 111 to the adder 177 via a contact “b” and the sign inverter 166 when the input signal has the low level. The switch 167 outputs the output signal of the BPF 111 to the adder 176 via a contact “a” when the input signal has the high level, and outputs the output signal of the BPF 111 to the adder 176 via a contact “b” and the sign inverter 166 when the input signal has the low level. The switch 168 outputs the output signal of the BPF 112 to the adder 176 via a contact “a” when the input signal has the high level, and outputs the output signal of the BPF 112 to the adder 176 via a contact “b” and the sign inverter 169 when the input signal has the low level. The switch 170 outputs the output signal of the BPF 112 to the adder 177 via a contact “a” when the input signal has the high level, and outputs the output signal of the BPF 112 to the adder 177 via a contact “b” and the sign inverter 169 when the input signal has the low level.

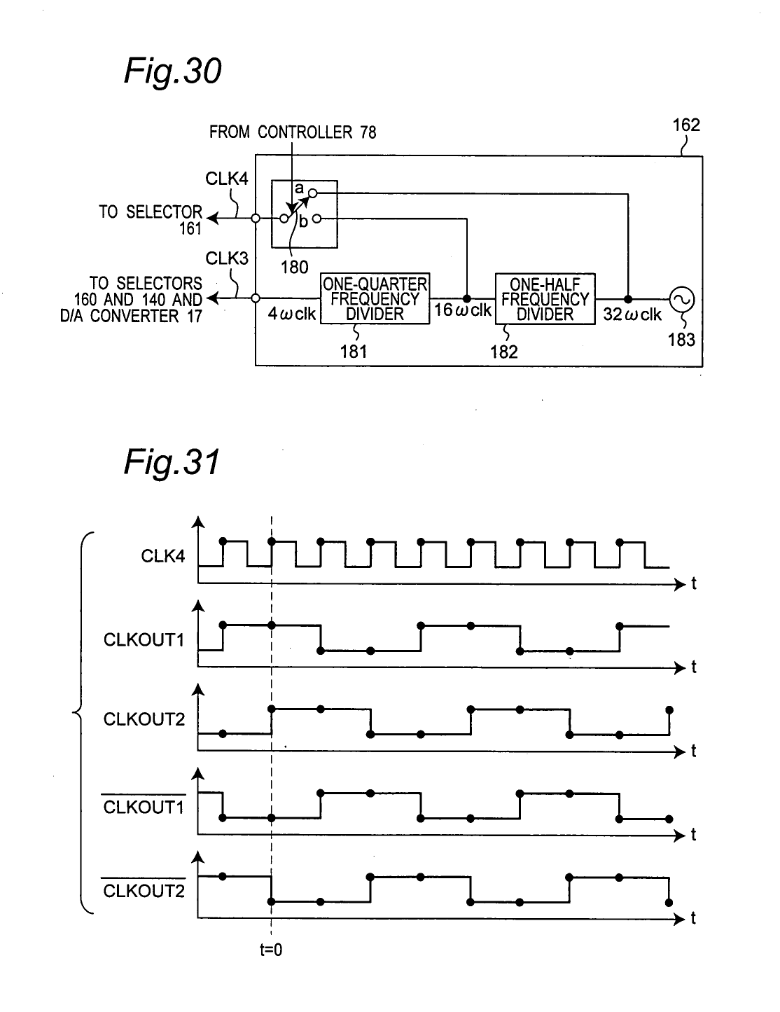

FIG. 30 is a block diagram showing a detailed configuration of the clock signal generator circuit 162 of FIG. 27. Referring to FIG. 30, the clock signal generator circuit 162 is configured to include a switch 180, a one-quarter frequency divider 181, a one-half divider 182 and a clock signal generator 183. The clock signal generator 183 generates and outputs a signal having a frequency of 32ωclk. The one-half divider 182 halves the frequency of the signal outputted from the clock signal generator 183, and generates and outputs a signal having a frequency of 16ωclk. The one-quarter frequency divider 181 divides the frequency of the signal outputted from the one-half divider 182 by four, generates a signal having a frequency of 4ωclk, and outputs the signal having the frequency of 4ωclk to the selectors 160 and 140 and the D/A converter 17. The switch 180, which is controlled by the controller 78, outputs the signal having the frequency of 32ωclk to the selector 161 via a contact “a”, and outputs the signal having the frequency of 16ωclk to the selector 161 via a contact “b”.

FIG. 31 is a waveform diagram showing operation performed by the clock control circuit 175 of FIG. 29. Referring to FIG. 31, by way of example, an instance in which the switch 180 is controlled to the contact “b” side by the controller 78 will be described. FIG. 31 shows the clock signal CLK4 generated by the clock signal generator circuit 162 and having the frequency of 16ωclk, clock signals CLKOUT1 and CLKOUT2 obtained by causing the orthogonal clock generator 1753 to divide the clock signal CLK4 by four, and inverted signals C̅L̅K̅O̅U̅T̅1̅ and C̅L̅K̅O̅U̅T̅2̅ of the respective clock signals CLKOUT1 and CLKOUT2. In the present preferred embodiment, the orthogonal clock generator 1753 is the one-quarter frequency divider circuit. Alternatively, the orthogonal clock generator 1753 can be realized even as a one-half frequency divider circuit or an RF phase shifter although frequency relationship differs from that if the orthogonal clock generator 1753 is the one-quarter frequency divider circuit. For sake of generalization, it is assumed that an output frequency of the orthogonal clock generator 1753 is ωa, hereinafter. In this case, the clock signal CLKOUT1 can be regarded as cos(ωa·t)−sin(ωa·t) and the clock signal CLKOUT2 can be regarded as cos(ωa·t)+sin(ωa·t).

Referring back to FIG. 27, operation performed by the digital quadrature modulation circuit including the above-stated configurations will be described. The digital quadrature modulation circuit according to the present preferred embodiment operates similarly to that according to the fifth preferred embodiment of FIG. 11 up to the processing in which the ROFs 11 and 12 output the output signals I0 and Q0, respectively. Therefore, the descriptions of the operations up to that in which the ROFs 11 and 12 output the output signals I0 and Q0, respectively will be omitted.

The selector 160 inverts the signs of the inputted output signals I0 and Q0 and make selection, and outputs the signal IQH expressed by the following Equation (79). It is to be noted that a coefficient “b1” is a value decided by a state of the switch 164 of the selector 160, and that the coefficient “b1” is 1 when the switch 164 is in the non-inverted mode and is −1 in the inverted mode:
IQH=I0×cos(ωclk)t+b1×Q0×sin(ωclk)t (79).

The selector 140 inverts the sign of the inputted output signal IQH via the BPF 119 and the D/A converter 17 and makes selection, and outputs the output signals IH and QH expressed by the following Equations (80) and (81), respectively:

$$\begin{matrix}\begin{matrix}IH = [ \begin{matrix}I 0 \times cos \{ ( 2 ω clk ) t + π / 4 \} + b 1 \times \\ Q 0 \times sin \{ ( 2 ω clk ) t + π / 4 \}\end{matrix} ] / 2 + \\ [ I 0 - b 1 \times Q 0 ] / 2 \sqrt{2} ;\end{matrix} \\ and & ( 80 ) \\ \begin{matrix}QH = [ \begin{matrix}I 0 \times cos \{ ( 2 ω clk ) t - π / 4 \} + b 1 \times \\ Q 0 \times sin \{ ( 2 ω clk ) t - π / 4 \}\end{matrix} ] / 2 + \\ [ I 0 + b 1 \times Q 0 ] / 2 \sqrt{2} .\end{matrix} & ( 81 )\end{matrix}$$

The BPFs 111 and 112 band-pass filter the output signals IH and QH to eliminate frequency components (I0±Q0) from the output signals IH and QH and to extract required frequency components, and output the band-pass filtered signals to the selector 161, respectively. The output signals IH1 and QH1 of the BPFs 111 and 112 are expressed by the following Equations (82) and (83), respectively:

$$\begin{matrix}IH 1 = [ \begin{matrix}I 0 \times cos \{ ( 2 ω clk ) t + π / 4 \} + b 1 \times \\ Q 0 \times sin \{ ( 2 ω clk ) t + π / 4 \}\end{matrix} ] / 2 \\ and & ( 82 ) \\ QH 1 = [ \begin{matrix}I 0 \times cos \{ ( 2 ω clk ) t - π / 4 \} + b 1 \times \\ Q 0 \times sin \{ ( 2 ω clk ) t - π / 4 \}\end{matrix} ] / 2. & ( 83 )\end{matrix}$$

The selector 161 inverts the signs of the output signals IH1 and QH1 and makes selection, and outputs the signals IH2 and QH2, respectively. The output signals IH2 and QH2 have different values according to the state of the switch 164 of the selector 160 and those of the switches 171 to 174 of the selector 161.

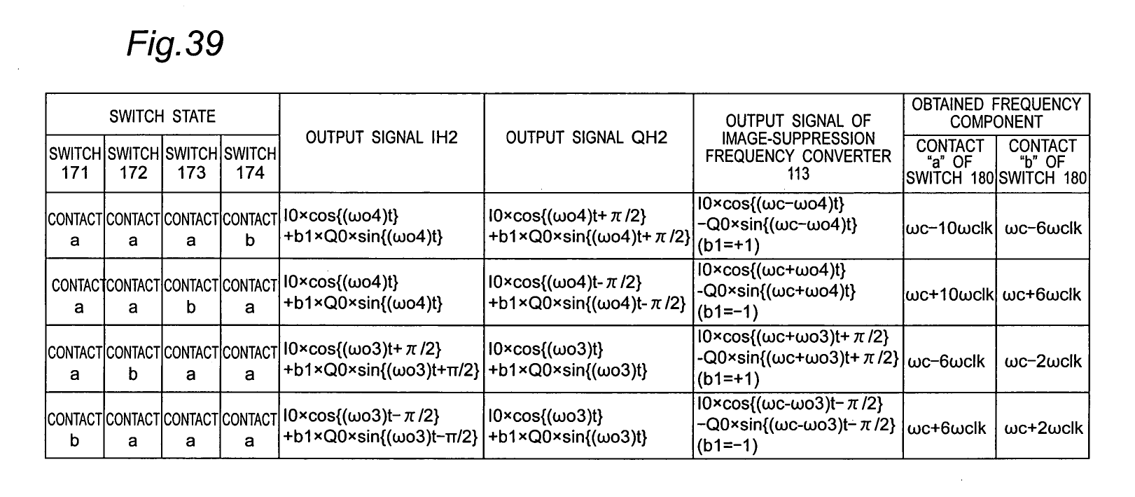

FIG. 39 is a table showing the output signals IH2 and QH2, an output signal of the image-suppression frequency converter 113 and obtained frequency components according to the state of the switch 164 of the selector 160 and those of the switches 171 to 174 of the selector 161. In FIG. 39, it is assumed that a frequency ωo3 is (2ωclk−ωa) and that ωo4 is (2ωclk+ωa). According to this configuration, since the frequency ωa is equal to 4ωclk in the present preferred embodiment, a plurality of channels can be switched over at channel intervals of 4ωclk centered around the frequency ωc.

As stated above, the digital quadrature modulation circuit according to the present preferred embodiment can switch over a plurality of channels based on different frequencies and can set the channel interval wider.

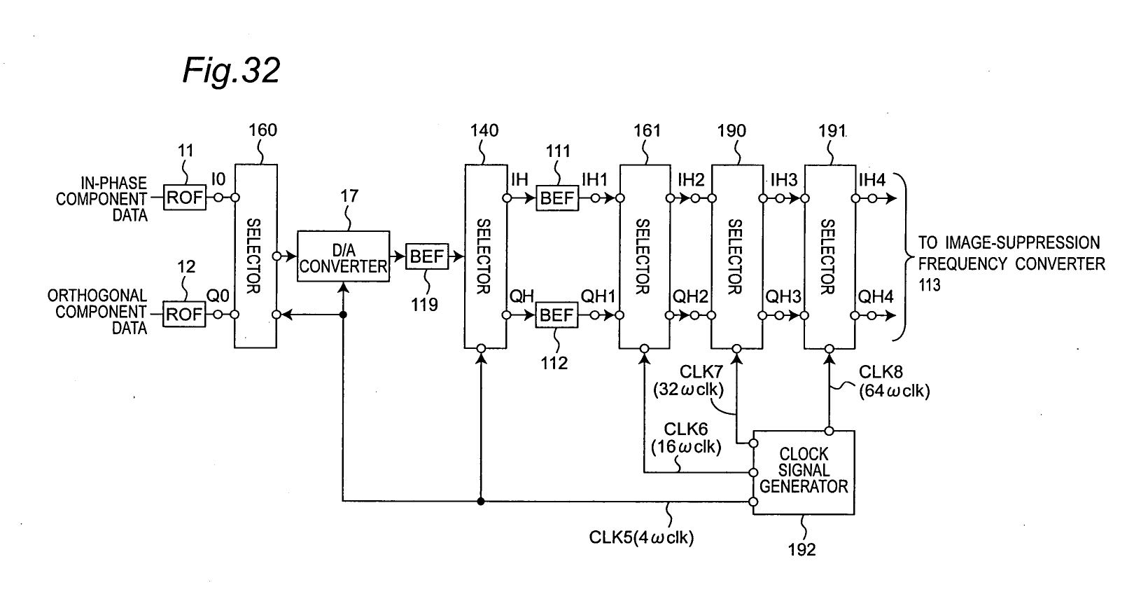

In addition, in the present preferred embodiment, one selector 161 is provided. However, the present invention is not limited to this configuration. As shown in FIG. 32, for example, a plurality of selectors may be provided. With this configuration of FIG. 32, it is advantageously possible to secure a wider channel selection width.

FIG. 32 is a block diagram showing a configuration of a digital quadrature modulation circuit according to a modified preferred embodiment of the tenth preferred embodiment. In FIG. 32, the digital quadrature modulation circuit differs from that according to the tenth preferred embodiment of FIG. 27 in that a plurality of cascade-connected selectors 190 and 190 having similar configurations to the selector 161 are provided in rear of the selector 161, and that a clock signal generator circuit 192 is provided in place of the clock signal generator circuit 162.

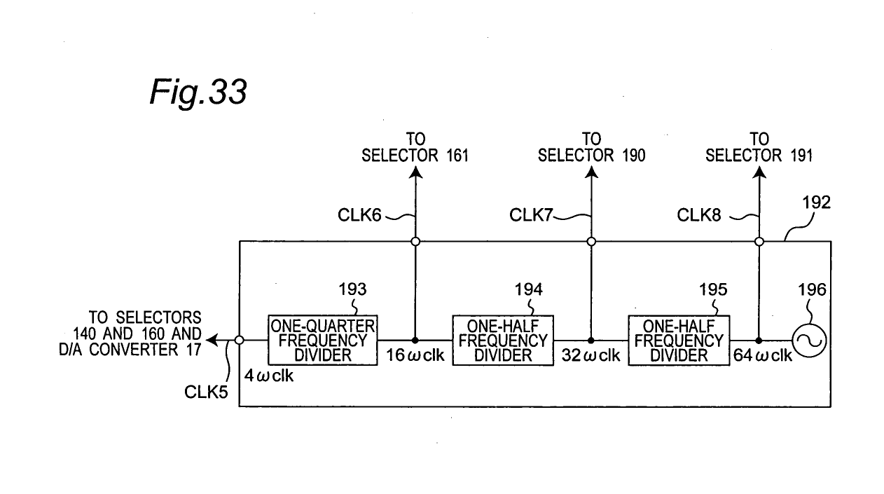

FIG. 33 is a block diagram showing a detailed configuration of the clock signal generator circuit 192 of FIG. 32. Referring to FIG. 33, the clock signal generator circuit 192 is configured to include a one-quarter frequency divider 193, one-half frequency dividers 194 and 195 and a clock signal generator 196. The clock signal generator 196 generates a signal having a frequency of 64ωclk, and outputs a clock signal CLK8 to the selector 191. The one-half frequency divider 195 halves the frequency of the signal outputted from the clock signal generator 196, generates a signal having a frequency of 32ωclk, and outputs a clock signal CLK7 to the selector 190. The one-half frequency divider 194 halves the frequency of the signal outputted from the one-half frequency divider 195, generates a signal having a frequency of 16ωclk, and outputs a clock signal CLK6 to the selector 161. The one-quarter frequency divider 193 divides the frequency of the signal outputted from the one-half frequency divider 194 by four, generates a signal having a frequency of 4ωclk, and outputs the signal to the selectors 140 and 160 and the D/A converter 17.

### Eleventh Preferred Embodiment

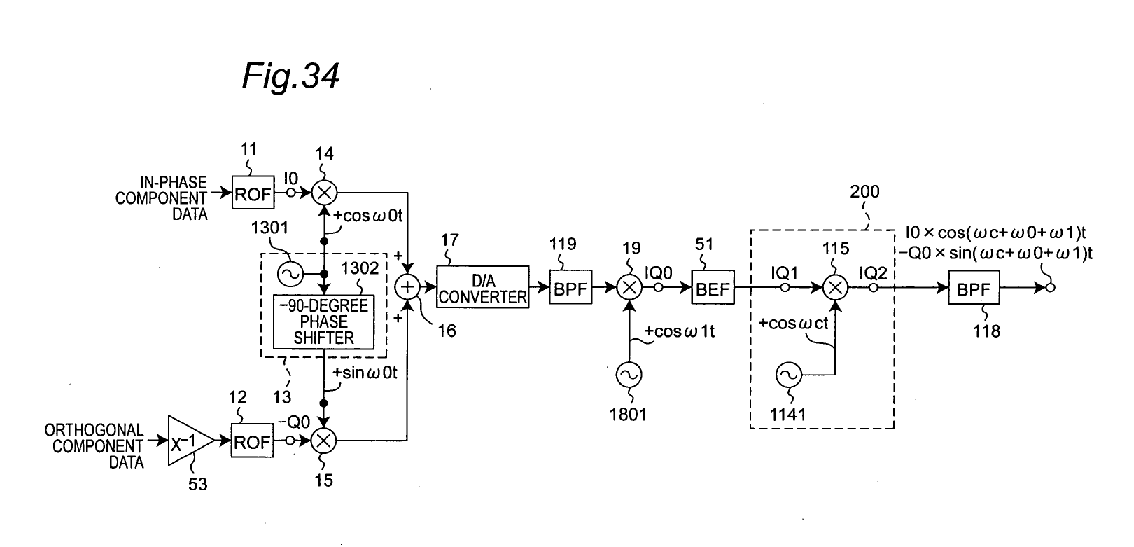

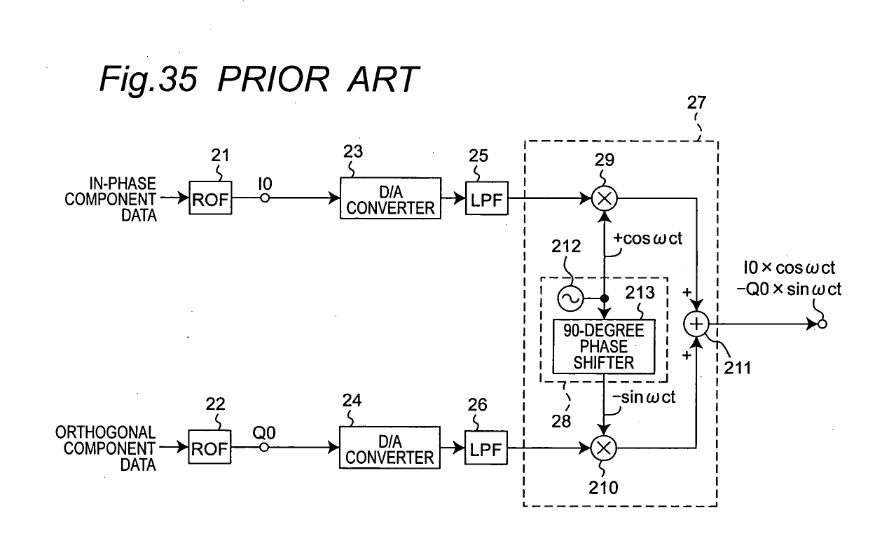

FIG. 34 is a block diagram showing a configuration of a digital quadrature modulation circuit according to an eleventh preferred embodiment of the present invention. In FIG. 34, the digital quadrature modulation circuit according to the present preferred embodiment differs from that according to the second preferred embodiment of FIG. 3 in that the mixer 110, the BPF 52 and the −90-degree phase shifter 1802 are removed, and that a frequency converter circuit 200 is provided in place of the image-suppression frequency converter 113. In other respects, since the digital quadrature modulation circuit according to the present preferred embodiment is similar to the digital quadrature modulation circuit according to the second preferred embodiment, the detailed description of the components denoted by the same reference numerals as those of FIG. 3 will be omitted.

Referring to FIG. 34, the frequency converter circuit 200 differs from the image-suppression frequency converter 113 of FIG. 3 in that the mixer 116, the adder 117 and the 90-degree phase shifter 1142 are removed.

The operation performed by the digital quadrature modulation circuit having the above-stated configurations will be described. The digital quadrature modulation circuit according to the present preferred embodiment operates similarly to that according to the first preferred embodiment of FIG. 1 up to the BPF 119. Therefore, the descriptions of the operations up to that performed by the BPF 119 will be omitted.

The mixer 19 multiplies an output signal of the BPF 119 by a local oscillation signal +cos ω1t generated by the local oscillation signal generator 1801. An output signal IQ0 of the mixer 19 is expressed by the following Equation (84). Further, the BPF 51 eliminates a component of a frequency (ω0−ω1) from the output signal IQ0. An output signal IQ1 of the BPF 51 is expressed by the following Equation (85):

$$\begin{matrix}\begin{matrix}I Q 0 = \{ I 0 \times cos ( ω 0 + ω 1 ) t - Q 0 \times sin ( ω 0 + ω 1 ) t \} / 2 + \\ \{ I 0 \times cos ( ω 0 - ω 1 ) t - Q 0 \times sin ( ω 0 - ω 1 ) t \} / 2 ;\end{matrix} \\ and & ( 84 ) \\ I Q 1 = \{ I 0 \times cos ( ω 0 + ω 1 ) t - Q 0 \times sin ( ω 0 + ω 1 ) t \} / 2. & ( 85 )\end{matrix}$$

A mixer 115 multiplies the output signal IQ1 by a carrier signal +cos ωct generated by a carrier signal generator 1141, and outputs a signal IQ2 to the BPF 118. The output signal IQ2 of the mixer 115 is expressed by the following Equation (86):

$$IQ 2 = [ \{ I 0 \times \{ cos ( ω c + ω 0 + ω 1 ) t + cos ( ω c - ω 0 - ω 1 ) t \} - Q 0 \times \{ sin ( ω c + ω 0 + ω 1 ) t - sin ( ω c - ω 0 - ω 1 ) t \} \} / 4. \qquad ( 86 )$$

The BPF 118 eliminates an image frequency component (ωc−ω0−ω1) from the output signal IQ2. Therefore, an output signal of the filter 118 is I0×cos(ωc+ω0+ω1)t/4−Q0×sin(ωc+ω0+ω1)t/4, and an orthogonally modulated signal is obtained at a fundamental frequency (ωc+ω0+ω1).

As stated above, the digital quadrature modulation circuit according to the present preferred embodiment can dispense with the image-suppression frequency converter, decrease the number of mixers to be used, make the circuit scale small, and reduce the electric power consumption. This leads to that a radio terminal which can ensure longer conversation time and longer waiting time can be provided.

Further, the generation of orthogonal signals using a frequency divider will be described with reference to FIGS. 42 to 45. FIG. 42 is an explanatory view for the generation of orthogonal signals using the frequency divider, and showing one delay flip-flop FF. In the delay flip-flop FF of FIG. 42, when an input clock (C) changes from an inactive state to an active state (e.g., from the low level to the high level), data is inputted from an input terminal D, and the data is outputted via an output terminal Q. The output data changes only when the clock changes from the low level to the high level.

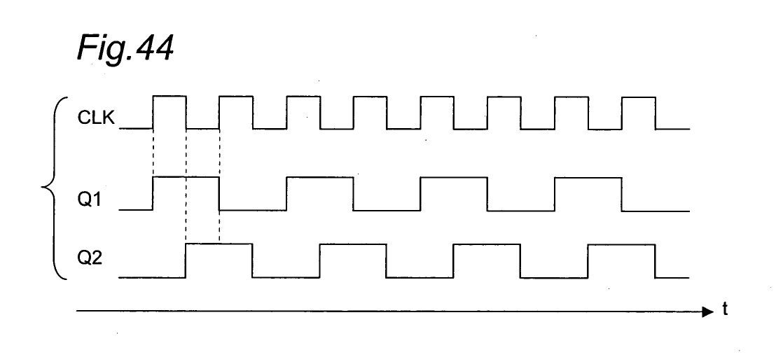

FIG. 43 is a circuit diagram of a one-half frequency divider constituted by two delay flip-flops FF1 and FF2 of FIG. 42 and an inverter INV1. FIG. 44 is a timing chart for explaining operation of FIG. 43. As shown in FIG. 43, when an invertion output terminal Q̅ of the delay flip-flop FF1 is connected to an input terminal D, the one-half frequency divider can be constituted. Further, if the delay flip-flop FF2 is additionally provided and the delay flip-flop FF2 is driven by an inverted signal (outputted from the inverter INV1) of the clock supplied to the delay flip-flop FF1, two output signals Q1 and Q2 orthogonal to each other can be obtained.

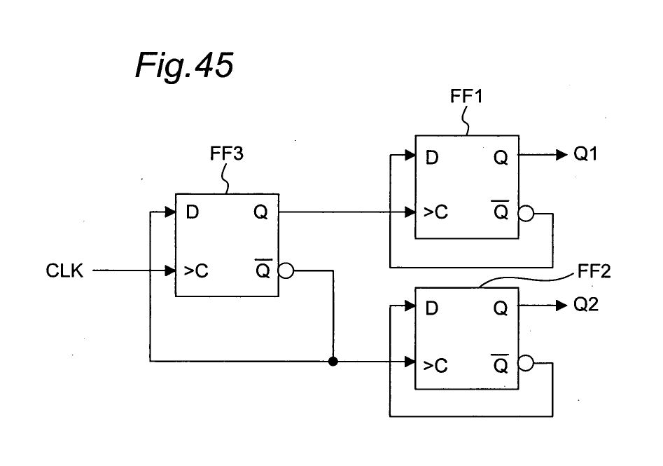

FIG. 45 is a circuit diagram of a one-quarter frequency divider constituted by three delay flip-flops FF11, FF12 and FF13 of FIG. 42. In the configuration of the one-half frequency divider described with reference to FIGS. 43 and 44, if a duty ratio of the clock signal is deviated from 50%, a phase difference between two divided signals Q1 and Q2 obtained by one-half frequency division is not equal to 90 degrees. As a result, orthogonality between the signals Q1 and Q2 is lost. As shown in FIG. 45, an output signal Q and an inverted signal Q̅ of the output signal Q of the delay flip-flop FF3, which are obtained by one-half frequency division, have a duty ratio exactly equal to 50%, and the phase of the signals Q and Q̅ are inverted from each other. Therefore, if the delay flip-flops FF1 and FF2 constituting a one-half frequency divider are driven using the output signals Q and Q̅ from the delay flip-flop FF3 as clocks, it is possible to obtain accurate orthogonal signals by one-quarter frequency division.

In the above descriptions, logic circuits are employed as the exemplary configuration. Alternatively, RF circuits are also applicable. Currently, a frequency divider is generally employed to generate orthogonal local oscillation signals used by an orthogonal demodulator, and an RC phase and λ/4 line are hardly used for this purpose for the following reasons. If the frequency divider is employed, then the orthogonality can be kept over a wide frequency band, and frequency pulling can be avoided since a modulation frequency is different from a local oscillation frequency.

As stated so far, the digital quadrature modulation circuit and the digital communication apparatus according to the present invention can decrease the number of D/A converters, make the circuit scale small, and reduce the electric power consumption, as compared with the prior arts.

The digital quadrature modulation circuit and the digital communication apparatus according to the present invention can be used in a radio communication terminal such as a mobile phone.

As stated, the present invention has been described in detail while referring to the preferred embodiments. However, the present invention is not limited to the preferred embodiments. Many modified preferred embodiments and changes can be made within the technical scope of the present invention as set forth in the following claims as obvious to those skilled in the art.

What is claimed is:

1. A digital quadrature modulation circuit comprising:
a quadrature modulator for orthogonally modulating a predetermined first local oscillation signal according to inputted first and second baseband signals, adding up two digital signals after the quadrature modulation, and outputting a digital signal after the addition;
a D/A converter for D/A-converting the digital signal after the quadrature modulation from the quadrature modulator into an analog signal, and outputting the analog signal; and
a frequency converter for converting a frequency of the analog signal from the D/A converter by mixing the analog signal with a predetermined second local oscillation signal, and outputting the analog signal after the frequency-conversion.

2. The digital quadrature modulation circuit as claimed in claim 1,
wherein the quadrature modulator comprises:
a first local oscillation signal generator for generating and outputting the first local oscillation signal and a first orthogonal local oscillation signal, which are orthogonal to each other;
a first multiplier for multiplying the first baseband signal by the first local oscillation signal, and outputting a multiplied signal;
a second multiplier for multiplying the second baseband signal by the first orthogonal local oscillation signal, and outputting a multiplied signal; and
an adder for adding up the signal from the first multiplier and the signal from the second multiplier, and outputting a digital signal after the addition.

3. The digital quadrature modulation circuit as claimed in claim 2,
wherein the second multiplier multiplies an inverted signal of the second baseband signal by the first orthogonal local oscillation signal, and outputs the multiplied signal.

4. The digital quadrature modulation circuit as claimed in claim 1,
wherein the frequency converter comprises:
a second local oscillation signal generator for generating and outputting the second local oscillation signal and a second orthogonal local oscillation signal, which are orthogonal to each other;
a first mixer for converting the frequency of the analog signal from the D/A converter by mixing the analog signal with the second local oscillation signal, and outputting a converted analog signal; and
a second mixer for converting the frequency of the analog signal from the D/A converter by mixing the analog signal with the second orthogonal local oscillation signal, and outputting a converted analog signal.

5. The digital quadrature modulation circuit as claimed in claim 1,
wherein the quadrature modulator comprises a first selector for sequentially selecting and outputting one of the first baseband signal, the second baseband signal, an inverted signal of the first baseband signal, and an inverted signal of the second baseband signal based on the first local oscillation signal.

6. The digital quadrature modulation circuit as claimed in claim 1,
wherein the frequency converter comprises at least one selector including a first selector, and
wherein the first selector comprises:
a first frequency divider for dividing the second local oscillation signal by a predetermined frequency-division ratio, and outputting a first frequency-divided signal;
a first orthogonal frequency-divided signal generator for generating a first orthogonal frequency-divided signal orthogonal to the first frequency-divided signal;
a first switch for selecting and outputting one of the analog signal from the D/A converter and an inverted signal of the analog signal based on the first frequency-divided signal; and
a second switch for selecting and outputting one of the analog signal from the D/A converter and the inverted signal of the analog signal based on the first orthogonal frequency-divided signal.

7. The digital quadrature modulation circuit as claimed in claim 6,
wherein the frequency converter further comprises a second and a third selectors,
wherein the second selector comprises:
a second frequency divider for dividing the second local oscillation signal by a predetermined frequency-division ratio, and outputting a second frequency-divided signal;
a second orthogonal frequency-divided signal generator for generating a second orthogonal frequency-divided signal orthogonal to the second frequency-divided signal;
a third switch for selecting and outputting one of the analog signal from the first switch and the inverted signal of the analog signal based on the second frequency-divided signal; and
a fourth switch for selecting and outputting one of the analog signal from the first switch and the inverted signal of the analog signal based on the second orthogonal frequency-divided signal, and
wherein the third selector comprises:
a third frequency divider for dividing the second local oscillation signal by a predetermined frequency-division ratio, and outputting a third frequency-divided signal;
a third orthogonal frequency-divided signal generator for generating a third orthogonal frequency-divided signal orthogonal to the third frequency-divided signal;
a fifth switch for selecting and outputting one of the analog signal from the second switch and the inverted signal of the analog signal based on the third frequency-divided signal; and
a sixth switch for selecting and outputting one of the analog signal from the second switch and the inverted signal of the analog signal based on the third orthogonal frequency-divided signal.

8. The digital quadrature modulation circuit as claimed in claim 7, further comprising a switching circuit for performing one of selectively switching a frequency of the second local oscillation signal and switching the frequency division ratios of the second and third frequency dividers.

9. The digital quadrature modulation circuit as claimed in claim 1, further comprising a first filter for extracting a first predetermined frequency component from the signal from the frequency converter.

10. The digital quadrature modulation circuit as claimed in claim 9,
wherein the first filter comprises a first frequency changer circuit for changing a frequency band of the first required frequency component.

11. The digital quadrature modulation circuit as claimed in claim 1, further comprising a second filter provided between the D/A converter and the frequency converter, and for extracting a second required frequency component from the analog signal from the D/A converter.

12. The digital quadrature modulation circuit as claimed in claim 11,
wherein the second filter comprises a second frequency changer circuit for changing a frequency band of the second required frequency component.

13. The digital quadrature modulation circuit as claimed in claim 1, further comprising first and second wave-shaping filters for wave-shaping the first and second baseband signals, respectively.

14. The digital quadrature modulation circuit as claimed in claim 13, further comprising a frequency divider for lowering a sampling frequency of at least one of the first and second wave-shaping filters.

15. A digital communication apparatus comprising a digital quadrature modulation circuit,
wherein the digital quadrature modulation circuit comprises:
a quadrature modulator for orthogonally modulating a predetermined first local oscillation signal according to respective inputted first and second baseband signals, adding up two digital signals after the quadrature modulation, and outputting a digital signal after the addition;
a D/A converter for D/A-converting the digital signal after the quadrature modulation from the quadrature modulator into an analog signal, and outputting the analog signal; and
a frequency converter for converting a frequency of the analog signal from the D/A converter by mixing the analog signal with a predetermined second local oscillation signal, and outputting the analog signal after the frequency-conversion.
